(19) United States
(12) Patent Application Publication
(10) Pub. No.: US 2018/0176743 A1
(43) Pub. Date: Jun. 21, 2018

(54) PHASED DETERMINATION OF CHANNEL-CORRELATION-BASED GROUPING METRICS FOR MULTI-USER TRANSMISSIONS

(71) Applicant: QUALCOMM Incorporated, San Diego, CA (US)

(72) Inventor: Ahmed Ragab Elsherif, San Jose, CA (US)

(21) Appl. No.: 15/380,763

(22) Filed: Dec. 15, 2016

(51) Int. Cl. H04W 4/06; H04B 17/336; H04B 7/06

(52) U.S. Cl. CPC H04W 4/06; H04B 7/0617; H04B 17/336

(57) ABSTRACT

Methods, systems, and devices for wireless communication are described. An access point (AP) may sequentially receive beamforming information for a channel from a plurality of wireless stations, the beamforming information comprising a first portion of beamforming information and a second portion of beamforming information. The AP may determine, before receiving all of the second portion of beamforming information, a first set of grouping metrics for the plurality of wireless stations indicating correlations between transmissions made by the plurality of wireless stations over the channel. The AP may determine a second set of grouping metrics for the wireless stations, and select a grouping metric from the first set of grouping metrics or the second set of grouping metrics. The AP may then transmit, over the channel, a multiple user transmission associated with the selected grouping metric.

### BACKGROUND

The present disclosure, for example, relates to wireless communication systems, and more particularly to techniques for determining channel-correlation-based grouping metrics for multi-user (MU) transmissions in a phased manner.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless local area network (WLAN) is an example of a multiple-access system, and may be widely deployed and used. Other examples of multiple-access systems may include code-division multiple access (CDMA) systems, time-division multiple access (TDMA) systems, frequency-division multiple access (FDMA) systems, and orthogonal frequency-division multiple access (OFDMA) systems.

A WLAN, such as a Wi-Fi (IEEE 802.11) network, may include an access point (AP) that may communicate with one or more stations (STAs) or mobile devices. In some cases, the AP may communicate with more than one STA simultaneously in a MU multiple-input multiple-output (MU-MIMO) transmission. The AP may assign a group of STAs to a MU-MIMO group and send a MIMO transmission to the group of STAs assigned to the MU-MIMO group. With opportunistic scheduling, the AP may change the STAs assigned to the MU-MIMO group during every sounding period based at least in part on, for example, availability of traffic, modulation and coding scheme (MCS) compatibility, etc. However, when a STA is grouped with other STAs in a MU-MIMO group that is incompatible (e.g., where each STA in the MU-MIMO group has high channel correlation), the packet error rate (PER) for the MU-MIMO group may increase for the group due to inter-user interference.

### SUMMARY

The present description discloses techniques for using compressed or non-compressed beamforming information for optimizing MU operations (e.g., MU-MIMO operations). According to disclosed techniques, a wireless communication device (e.g., an AP or STA) may determine grouping metrics (GMs) for candidate MU groups (e.g., MU-MIMO groups) to enable selection of an optimal MU group for each of one or more levels or orders (e.g., an optimal MU-2 group, MU-3 group, etc., where an optimal MU-2 group, for example, is an MU-MIMO group of two users that transmit with less correlation than any other MU-MIMO group of two users). The grouping metric for each candidate MU group indicates a correlation between MU transmissions intended for the STAs of the candidate group.

In some examples, the GMs may be determined during multiple phases of operations (e.g., during a first phase of operation, a second phase of operation, etc.). In these examples, a first set of GMs may be determined after receipt of a first portion of beamforming information, and before receiving all of a second portion of beamforming information (e.g., before receiving all beamforming information). A second set of GMs may be determined after receipt of the second portion of beamforming information (e.g., after receiving all beamforming information). By beginning the determination of GMs after receipt of a first portion of beamforming information, the time to determine all of the needed GMs may be reduced, and in some cases, a best GM may be determined, selected, and used to transmit a first physical layer convergence protocol (PLCP) protocol data unit (PPDU) following receipt of all of the beamforming information for a set of STAs.

In one example, an apparatus for wireless communication is described. The apparatus may include a memory that stores instructions, and a processor coupled with the memory. The processor and the memory may be configured to sequentially receive beamforming information for a channel from a plurality of wireless stations. The beamforming information may include a first portion of beamforming information and a second portion of beamforming information. The processor and the memory may also be configured to determine, based at least in part on the first portion of beamforming information, and before receiving all of the second portion of beamforming information, a first set of grouping metrics of a plurality of grouping metrics for the plurality of wireless stations. The plurality of grouping metrics may indicate correlations between transmissions made by the plurality of wireless stations over the channel. The processor and the memory may be further configured to determine, based at least in part on the second portion of beamforming information, a second set of grouping metrics of the plurality of grouping metrics for the plurality of wireless stations; to select a grouping metric from the first set of grouping metrics or the second set of grouping metrics; and to transmit, over the channel, a multiple user transmission associated with the selected grouping metric. In some examples, the apparatus may be a wireless communication terminal and further include an antenna and a transceiver.

In one example, another apparatus for wireless communication is described. The apparatus may include means for sequentially receiving beamforming information from a plurality of wireless stations. The beamforming information may include a first portion of beamforming information and a second portion of beamforming information. The apparatus may also include means for determining, based at least in part on the first portion of beamforming information, and before receiving all of the second portion of beamforming information, a first set of grouping metrics of a plurality of grouping metrics for the plurality of wireless stations. The plurality of grouping metrics may indicate correlations between transmissions made by the plurality of wireless stations. The apparatus may further include means for determining, based at least in part on the second portion of beamforming information, a second set of grouping metrics of the plurality of grouping metrics for the plurality of wireless stations; means for selecting a grouping metric from the first set of grouping metrics or the second set of grouping metrics; and means for transmitting a multi-user transmission associated with the selected grouping metric. In some examples, the apparatus may be a wireless communication terminal and further include an antenna and a transceiver.

In one example, a method for wireless communication is described. The method may include sequentially receiving beamforming information from a plurality of wireless stations. The beamforming information may include a first portion of beamforming information and a second portion of beamforming information. The method may also include determining, based at least in part on the first portion of beamforming information, and before receiving all of the second portion of beamforming information, a first set of grouping metrics of a plurality of grouping metrics for the plurality of wireless stations. The plurality of grouping metrics may indicate correlations between transmissions made by the plurality of wireless stations. The method may also include determining, based at least in part on the second portion of beamforming information, a second set of grouping metrics of the plurality of grouping metrics for the plurality of wireless stations; selecting a grouping metric from the first set of grouping metrics or the second set of grouping metrics; and transmitting a multi-user transmission associated with the selected grouping metric.

In one example, a non-transitory computer readable medium storing code for wireless communication is described. The code may include instructions executable by a processor to sequentially receive beamforming information for a channel from a plurality of wireless stations. The beamforming information may include a first portion of beamforming information and a second portion of beamforming information. The code may also include instructions executable by the processor to determine, based at least in part on the first portion of beamforming information, and before receiving all of the second portion of beamforming information, a first set of grouping metrics of a plurality of grouping metrics for the plurality of wireless stations. The plurality of grouping metrics may indicate correlations between transmissions made by the plurality of wireless stations over the channel. The code may also include instructions executable by the processor to determine, based at least in part on the second portion of beamforming information, a second set of grouping metrics of the plurality of grouping metrics for the plurality of wireless stations; to select a grouping metric from the first set of grouping metrics or the second set of grouping metrics; and to transmit, over the channel, a multiple user transmission associated with the selected grouping metric.

In some examples of the method, apparatus, and computer-readable medium described above, determining the first set of grouping metrics may include determining a first set of pairwise grouping metrics based at least in part on beamforming information received for a first set of the plurality of wireless stations.

Some examples of the method, apparatus, and computer-readable medium described above may further include processes, features, means, instructions, or code for determining a number of wireless stations in the first set of the plurality of wireless stations based at least in part on a time to determine the first set of grouping metrics before receiving all of the second portion of the beamforming information.

In some examples of the method, apparatus, and computer-readable medium described above, determining the first set of grouping metrics may include iteratively, based at least in part on the first portion of beamforming information, selecting a lower order grouping metric and determining a higher order set of grouping metrics for each selected lower order grouping metric.

In some examples of the method, apparatus, and computer-readable medium described above, determining the second set of grouping metrics may include determining a second set of pairwise grouping metrics based at least in part on the second portion of beamforming information.

Some examples of the method, apparatus, and computer-readable medium described above may further include processes, features, means, instructions, or code for selecting a pairwise grouping metric from the second set of pairwise grouping metrics. The pairwise grouping metric may indicate a lowest correlation between transmissions within the second set of pairwise grouping metrics. The method, apparatus, and computer-readable medium may further include processes, features, means, instructions, or code for comparing the selected pairwise grouping metric to a predetermined threshold correlation value, and determining no other grouping metrics within the second set of grouping metrics when the comparing indicates that the selected pairwise grouping metric indicates more correlation between transmissions than the predetermined threshold correlation value.

Some examples of the method, apparatus, and computer-readable medium described above may further include processes, features, means, instructions, or code for selecting a first pairwise grouping metric from the first set of pairwise grouping metrics. The first pairwise grouping metric may indicate a lowest correlation between transmissions within the first set of pairwise grouping metrics. The method, apparatus, and computer-readable medium may further include processes, features, means, instructions, or code for selecting a second pairwise grouping metric from the second set of pairwise grouping metrics. The second pairwise grouping metric may indicate a lowest correlation between transmissions within the second set of pairwise grouping metrics. The method, apparatus, and computer-readable medium may further include processes, features, means, instructions, or code for comparing the second pairwise grouping metric to the first pairwise grouping metric, and for iteratively, based at least in part on the first portion of beamforming information and the second portion of beamforming information, selecting a lower order grouping metric and determining a higher order set of grouping metrics, for each selected lower order grouping metric.

Some examples of the method, apparatus, and computer-readable medium described above may further include processes, features, means, instructions, or code for selecting a pairwise grouping metric from the first set of pairwise grouping metrics. The pairwise grouping metric may indicate a lowest correlation between transmissions within the first set of pairwise grouping metrics. The method, apparatus, and computer-readable medium may further include processes, features, means, instructions, or code for comparing the selected pairwise grouping metric to a predetermined threshold correlation value, and determining the second set of grouping metrics of the plurality of grouping metrics when the comparing indicates that the pairwise grouping metric indicates more correlation between transmissions than the predetermined threshold correlation value.

In some examples of the method, apparatus, and computer-readable medium described above, the first set of grouping metrics of the plurality of grouping metrics may be determined in at least two phases, after receiving beamforming information from different subsets of the plurality of wireless stations.

In some examples of the method, apparatus, and computer-readable medium described above, the beamforming information may include feedback signal-to-noise ratio (SNR) values and beamforming feedback matrices.

### BRIEF DESCRIPTION OF THE DRAWINGS

FIG. 1 illustrates an example of a wireless communication system, such as a WLAN, that supports using compressed or non-compressed beamforming information for optimizing MIMO operations in accordance with various aspects of the present disclosure.

FIG. 2 illustrates an example wireless communications scenario in which a beamformer wireless device (e.g., an AP) receives beamforming information from each of a plurality of beamformee wireless devices (e.g., STAs) sequentially, in accordance with various aspects of the present disclosure.

FIGS. 3A-3G show diagrams of vectors, of angles and distances between vectors, and of projections of vectors in accordance with various aspects of the present disclosure.

FIGS. 4A-4C show examples of candidate MU-MIMO group selection trees illustrating tree-based selection techniques in accordance with various aspects of the present disclosure.

FIG. 5 shows a flow chart that illustrates an example of a method for phased determination of channel-correlation based grouping metrics for MU transmissions in accordance with various aspects of the present disclosure.

FIG. 6 shows a flow chart that illustrates an example of a method for phased determination of channel-correlation based grouping metrics for MU transmissions, in accordance with various aspects of the present disclosure.

FIGS. 7 through 9 show block diagrams of a device that supports phased determination of channel-correlation-based grouping metrics for multiple user transmissions in accordance with aspects of the present disclosure.

FIG. 10 illustrates a block diagram of a system including an AP that supports phased determination of channel-correlation-based grouping metrics for multiple user transmissions in accordance with aspects of the present disclosure.

FIGS. 11 and 12 illustrate methods for phased determination of channel-correlation-based grouping metrics for multiple user transmissions in accordance with aspects of the present disclosure.

### DETAILED DESCRIPTION

According to aspects of the present disclosure, a wireless communication device, such as an AP, may utilize compressed or non-compressed beamforming information to optimize MU operations (e.g., MU-MIMO operations). The AP may estimate a MU signal-to-interference-plus-noise ratio (SINR) metric for each STA in a candidate MU group and use the MU SINR metrics with respect to various MIMO operations. Additionally or alternatively, the AP may determine grouping metrics for candidate MU-MIMO groups to enable selection of an optimal MU-MIMO group for each of one or more levels or orders (e.g., an optimal MU-2 group, MU-3 group, etc.). The AP may determine the MU SINR metric for a particular STA, or a grouping metric for a particular candidate MU-MIMO group, based at least in part on compressed or non-compressed beamforming information associated with each STA in a candidate MU-MIMO group. When the AP receives beamforming information from a plurality of STAs sequentially, the AP may determine grouping metrics for the STAs in a plurality of phases of operation, with each phase of operation being initiated after the receipt of beamforming information from a next one or more STAs.

In some examples, the beamforming information used by an AP to determine MU SINR metrics or grouping metrics may include feedback signal-to-noise ratio (SNR) values and compressed or non-compressed beamforming feedback matrices. An MU SINR metric for a particular STA, or a grouping metric for a particular candidate MU-MIMO group, may be based at least in part on the received feedback SNR values and the received beamforming feedback matrices associated with the STAs in a candidate MU group. The AP may decompress a compressed beamforming feedback matrix based at least in part on angles (e.g., phi Φ and psi Ψ angles) associated with the rows and columns of the compressed beamforming feedback matrix, to obtain a beamforming feedback matrix for a STA.

With the beamforming feedback matrix for each STA in a candidate MU-MIMO group, the AP may determine a beamforming steering matrix associated with the candidate MU-MIMO group in accordance with some implementations. The beamforming steering matrix may be based at least in part on the received SNR values and received beamforming feedback matrices (which have been decompressed if compressed) to obtain beamforming feedback matrices of the STAs in the candidate MU-MIMO group, and on the grouping metrics (e.g., on optimal MU-MIMO groups that have been identified from the candidate MU-MIMO groups). The multi-user SINR metric for each STA may be, in turn, determined based at least in part on the determined beamforming steering matrix associated with a candidate MU-MIMO group.

The MU SINR metrics for the STAs provide the AP with estimations of the different levels of channel correlation and associated inter-user interference that a particular STA may experience if that particular STA were to be included in various possible MIMO transmission groupings. As such, the AP may form efficient MU groups of STAs for MIMO transmissions, as well as accurately determine a proper modulation and coding scheme (MCS) for each STA in the corresponding MU transmission group. The MCS for each STA may be based at least in part on the MU SINR metrics. For example, the AP may determine MU SINR metrics for the STAs in an MU group and map the MU SINR metric of a particular STA to a MCS (e.g., selecting from predefined MCSs corresponding to a value or range of values associated with the MU SINR metrics).

By contrast, certain conventional APs solely utilize packet error rate (PER) history to decide the MCS to be utilized for a STA in a MIMO group. However, if a STA joins a poor MU group (e.g., having large channel correlation and inter-user interference during the MIMO transmission), the resulting PER for that transmission occurrence can significantly impact the PER history and improperly lower MCS for that STA. If that STA then joins a good MU group (e.g., having small channel correlation and negligible inter-user interference during the MIMO transmission), that STA can still use an artificially low MCS based on the PER-based rate adaptation practices associated with a conventional AP.

In some examples, an AP in accordance with aspects of the present disclosure may set the MCS of a particular STA based at least in part on the MU SINR metrics associated with candidate MU-MIMO groups. Moreover, the AP may determine a correlation metric based at least in part on, or independent of, the MU SINR metrics. For example, the correlation metric can be an average, median, or mean distribution of the MU SINR metrics of the STAs for a candidate MU-MIMO group. As such, the AP may use the correlation metric to determine whether the candidate MU-MIMO group is an efficient MU-MIMO transmission and whether to remove one or more STAs from the candidate MU-MIMO group. Correlation metrics relating to multiple candidate transmission groups may be analyzed by the AP to detect changes and patterns associated with channel correlations among the STAs, and to form efficient MU transmission groups. In this regard, the AP may use the MU SINR metrics and correlation metrics to optimize MCS rate adaptation, MU grouping of STAs, MU transmission group ranking and scheduling, etc.

In some examples, an AP in accordance with aspects of the present disclosure may determine grouping metrics for various candidate MU-MIMO groups to determine the compatibility of STAs in a candidate MU-MIMO group (e.g., to determine whether the spatial streams of MU-MIMO transmissions intended for the STAs of the candidate group have good orthogonality and low cross-user interference). The AP can also select an optimal MU-MIMO group for each of one or more levels or orders (e.g., an optimal MU-2 group, MU-3 group, etc.), or identify a set of spatial streams to use for multi-spatial stream STAs. The grouping metrics, optimal MU-MIMO groups, or identified sets of spatial streams can be forwarded to a scheduler to make a final grouping/scheduling decision.

In some examples, an AP in accordance with aspects of the present disclosure may receive beamforming information from a plurality of STAs. An MU SINR metric for a particular STA, or a grouping metric for a particular candidate MU-MIMO group, may be based at least in part on the received feedback SNR values and the received beamforming feedback matrices associated with the STAs in a candidate MU group. The AP may decompress a compressed beamforming feedback matrix based at least in part on angles (e.g., phi Φ and psi Ψ angles) associated with the rows and columns of the compressed beamforming feedback matrix, to obtain a beamforming feedback matrix for a STA.

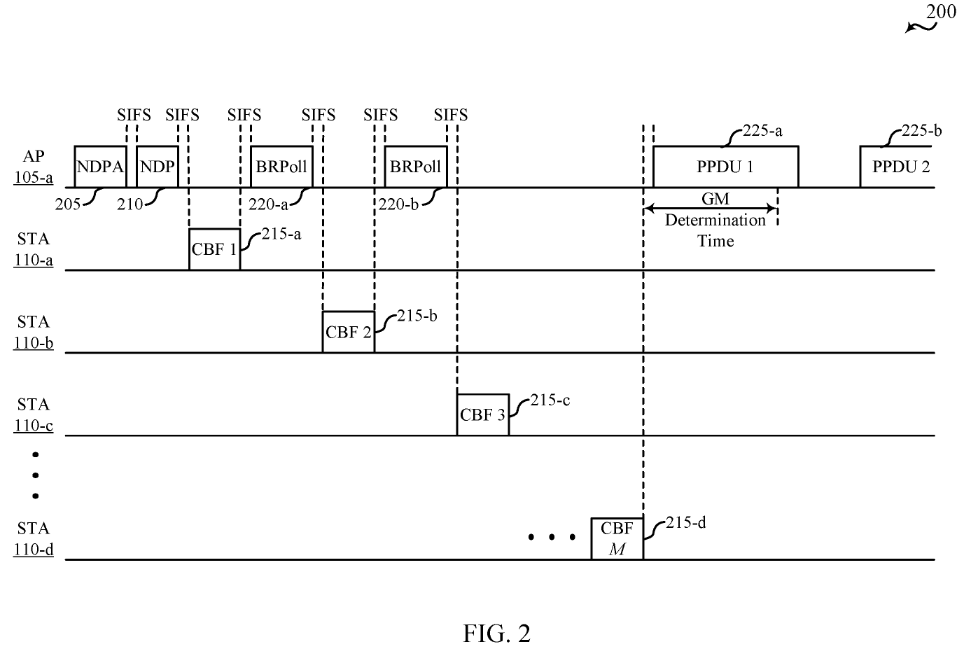

In some examples, an AP in accordance with aspects of the present disclosure may sequentially receive beamforming information from a plurality of STAs. For example, an AP that does not support uplink (UL) OFDMA/UL-MIMO may sequentially receive beamforming information (e.g., coordinated beamforming (CBF) information) using a repeated NDPA-NDP-CBF sequence or a NDPA-NDP-CBF1-BRPoll2-CBF2, . . . sequence, as described with reference to FIG. 2. When an AP sequentially receives beamforming information, GMs may be determined in a phased manner (e.g., in a first phase of operation, a second phase of operation, etc.). In these examples, a first set of GMs may be determined after receipt of a first portion of beamforming information, and before receiving all of a second portion of beamforming information (e.g., before receiving all beamforming information). A second set of GMs may be determined after receipt of the second portion of beamforming information (e.g., after receiving all beamforming information). By beginning the determination of GMs after receipt of a first portion of beamforming information, the time to determine all of the needed GMs may be reduced, and in some cases, a best GM may be determined, selected, and used to transmit a first PPDU following receipt of all of the beamforming information for a set of STAs.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

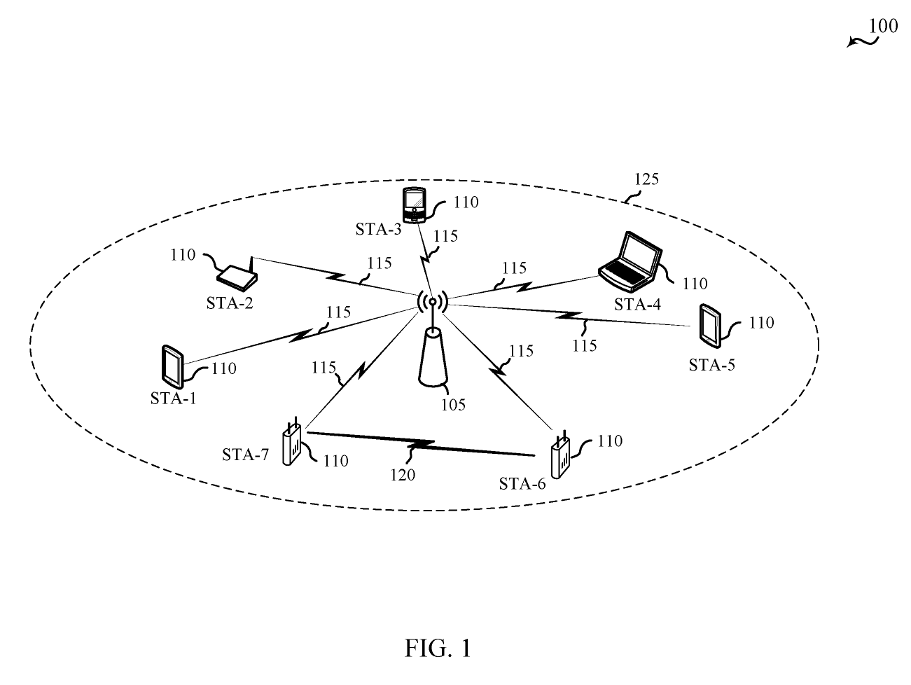

Referring first to FIG. 1, a block diagram illustrates an example of a wireless local area network (WLAN) 100 in accordance with various aspects of the present disclosure. WLAN 100 includes an access point (AP) 105 and STAs 110 labeled as STA-1 through STA-7. STAs 110 can be mobile handsets, tablet computers, personal digital assistants (PDAs), other handheld devices, netbooks, notebook computers, tablet computers, laptops, desktop computers, display devices (e.g., TVs, computer monitors, etc.), printers, etc. While only one AP 105 is illustrated, WLAN 100 can alternatively have multiple APs 105. STAs 110 can also be referred to as mobile stations (MS), mobile devices, access terminals (ATs), user equipment (UEs), subscriber stations (SSs), or subscriber units. STAs 110 associate and communicate with AP 105 via communication links 115. Each AP 105 has a coverage area 125 such that STAs 110 within that area are within range of the AP 105. STAs 110 are dispersed throughout coverage area 125. Each STA 110 may be stationary or mobile. Additionally, each AP 105 and STA 110 can have multiple antennas.

While STAs 110 are capable of communicating with each other through AP 105 using communication links 115, STAs 110 can also communicate directly with each other via direct wireless communication links 120. Direct wireless communication links can occur between STAs 110 regardless of whether any of the STAs is connected to an AP 105. As such, a STA 110 or like device can include techniques for using compressed or non-compressed beamforming information for optimizing MIMO operations as described herein with respect to an AP 105.

The STAs 110 and AP 105 shown in FIG. 1 communicate according to the WLAN radio and baseband protocol including physical (PHY) and medium access control (MAC) layers from IEEE 802.11, and its various versions including, but not limited to, 802.11b, 802.11g, 802.11a, 802.11n, 802.11ac, 802.11ad, 802.11ah, 802.11z, 802.11ax, etc. Thus, WLAN 100 implements a contention-based protocol that allows a number of devices (e.g., STAs 110 and APs 105) to share the same wireless medium (e.g., a channel) without pre-coordination. To prevent several devices from transmitting over the channel at the same time, each device in a BSS operates according to certain procedures that structure and organize medium access, thereby mitigating interference between the devices.

In WLAN 100, AP 105 utilizes techniques for using compressed beamforming information (e.g., very high throughput (VHT) compressed beamforming (CBF) report information) for optimizing MIMO operations. AP 105 utilizes certain transmission techniques such as MIMO and MU-MIMO. A MIMO communication typically involves multiple transmitter antennas (e.g., at an AP 105) sending a signal or signals to multiple receive antennas (e.g., at a STA 110). Each transmitting antenna transmits independent data (or spatial) streams to increase spatial diversity and the likelihood of successful signal reception. In other words, MIMO techniques use multiple antennas on an AP 105 and/or multiple antennas on a STA 110 in the coverage area 125 to take advantage of multipath environments to transmit multiple data streams.

AP 105 also implements MU-MIMO transmissions in which AP 105 simultaneously transmits independent data streams to multiple STAs 110. In one example of an MU-N transmission (e.g., MU-2, MU-3, MU-4, etc.), an AP 105 simultaneously transmits signals to N STAs. Thus, when AP 105 has traffic for many STAs 110, the AP 105 increases network throughput by aggregating individual streams for each STA 110 in the group into a single MU-MIMO transmission.

In implementing various MU-MIMO techniques and operations, AP 105 (e.g., a beamformer device) relies on multi-user channel sounding procedures performed with the STAs 110 (e.g., a beamformee devices) in the coverage area 125 to determine how to radiate energy in a preferred direction. AP 105 may sound the channel by transmitting null data packet announcement (NDPA) frames and null data packet (NDP) frames to a number of STAs 110 such as STA-1, STA-2, STA-3, STA-4, STA-5, and STA-6. AP 105 has knowledge that STA-7 does not support MU-MIMO operations, for instance, and does not include STA-7 in the multi-user channel sounding procedure.

FIG. 2 illustrates an example wireless communications system 200 in which a beamformer wireless device (e.g., an AP 105-a) receives beamforming information from each of a plurality of beamformee wireless devices (e.g., STAs 110-a, 110-b, and 110-c) sequentially, in accordance with various aspects of the present disclosure. In some examples, the AP 105-a and STAs 110-a, 110-b, and 110-c may be examples of the AP 105 and STAs 110 of FIG. 1.

AP 105-a may sound the channel by transmitting null data packet announcement (NDPA) frames 205 and null data packet (NDP) frames 210 to a number of STAs 110 such as STA 110-a, 110-b, and 110-c. The NDPA frame 205 and NDP frame 210 may be separated in time by a short interframe spacing (SIFS).

In response to receiving the NDPA frame 205, and after a SIFS following the NDP frame 210, a first of the STAs (e.g., STA-1 110-a) may transmit beamforming information (e.g., CBF 1 215-a (e.g., a VHT CBF frame)) to the AP 105-a.

In response to receiving CBF 1 215-a, and after a SIFS following CBF 1 215-a, AP 105 may transmit a beamforming report poll frame (e.g., BRPoll 220-a) to trigger the transmission of a CBF 2 215-b by a second of the STAs (e.g., STA-2 110-b). The AP 105-a and STAs may then alternately and sequentially transmit BRPoll 220-b, CBF 3 215-c, etc., until all beamforming information (e.g., beamforming information from M STAs) is received by the AP 105-a. The CBFs 215 contain CBF report information, portions of which AP 105 may use to determine MU SINR metrics for the STAs 110.

The CBFs 215 may include, for example, feedback information such as compressed beamforming feedback matrix V compressed in the form of angles (i.e., phi Φ and psi Ψ angles) that are quantized according to a standard (e.g., IEEE 802.11ac). The CBFs 215 may also include feedback signal-to-noise ratio (SNR) values (e.g., an Average SNR of Space-Time Stream Nc, where Nc is the number of columns in the compressed beamforming feedback matrix V). Each SNR value per tone in stream i (before being averaged) may correspond to the SNR associated with the column i of the beamforming feedback matrix V determined for the STA 110. The feedback SNR values may be based at least in part on the NDP frames 210 in the channel sounding procedure, and therefore each of these feedback SNR values may generally correspond to a SNR that a particular STA 110 may experience in a single-user (SU) transmission from AP 105-a to the particular STA 110.

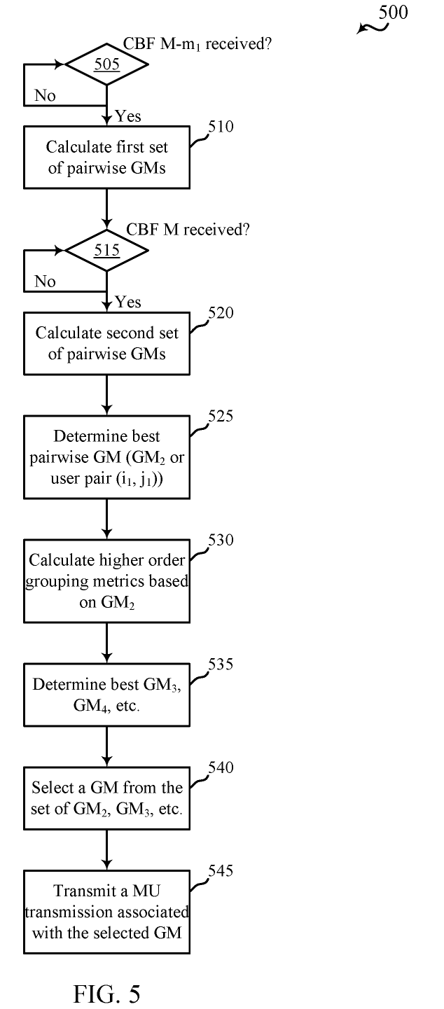

AP 105-a may sequentially collect the CBFs 215 from the STAs 110 and use the feedback information to determine the SINR metrics, grouping metrics, and beamforming steering matrices in some examples. In some examples, AP 105-a may transmit a PPDU 1 225-a and a PPDU 2 225-b following receipt of the Mth CBF (e.g., CBF M225-d). PPDU 2 225-b may be transmitted later in time than PPDU 1 225-a. If grouping metrics based on CBF 1 215-a, CBF 2 215-b, CBF 3 215-c, . . . CBF M215-d are not determined until after CBF M 215-d is received, an optimum channel-correlation-based grouping metric on which an MU transmission may be based may not be determined until after the time for transmitting PPDU 1 225-a, and the optimum channel-correlation-based grouping metric may not be used for a MU transmission until PPDU 2 225-b. However, FIGS. 5 & 6 disclose methods for determining grouping metrics in accordance with different phases of operations, beginning at a time prior to receiving CBF M 215-d and thereby reducing the time needed to determine all of the needed grouping metrics. In some examples, determining some grouping metrics prior to receiving all beamforming information, may allow PPDU 1 225-a to be transmitted using the optimum channel-correlation-based grouping metric.

It is to be understood that the multi-user channel sounding procedures described herein are provided as non-limiting examples. Other channel sounding procedures for obtaining compressed or non-compressed beamforming information can be used for optimizing MIMO operations as would be apparent to a skilled person given the benefit of the present disclosure.

In an example of the AP 105-a determining an MU SINR metric associated with a the STA-a 110-a, the AP 105-a may determine to analyze a candidate MU-MIMO group consisting of STA-1 110-a, STA-2 110-b, and STA-3 110-c. In this example, the number of STAs (or users) is 3. Further, and by way of example, the number of space-time streams (N_{STS}) per user may be 1, the number of transmit antennas (Nₜₓ) at AP 105-a may be 4, and the number of receive antennas (Nᵣₓ) at STA-1 110-a may be 1. Symbols propagate from the four transmit antennas of AP 105-a to the receive antenna of STA-1 110-a by way of four separate radio paths: channel element h1,1 from the first transmit antenna of AP 105-a to the receive antenna of STA-1 110-a; channel element h1,2 from the second transmit antenna of AP 105-a to the receive antenna of STA-1 110-a; channel element h1,3 from the third transmit antenna of AP 105-a to the receive antenna of STA-1 110-a; and channel element h1,4 from the fourth transmit antenna of AP 105-a to the receive antenna of STA-1 110-a. The received signals can be expressed as follows:

$$[ \begin{matrix}{y}_{1} \\ {y}_{2} \\ {y}_{3}\end{matrix} ] = H \cdot W \cdot [ \begin{matrix}{x}_{1} \\ {x}_{2} \\ {x}_{3}\end{matrix} ] + n$$

where x₁, x₂, and x₃ are the signals for STA-1, STA-2, and STA-3, respectively, sent from the transmit antennas of AP 105-a; y₁, y₂, and y₃ are the signals that arrive at the receive antenna of STA-1 110-a, the receive antenna of STA-2 110-b, and the receive antenna of STA-3 110-c, respectively. H expresses the way in which the transmitted symbols are attenuated, phase-shifted, distorted, etc. as the symbols travel from the transmit antennas to the receive antennas. W represents the beamforming steering matrix to transmit signals x₁, x₂, and x₃ as determined using the compressed or non-compressed beamforming information received by AP 105-a during the channel sounding procedure, and n represents the received noise and interference.

Thus, y₁ can be expressed as follows:

$$\begin{matrix}{y}_{1} = [ \begin{matrix}- & {h}_{1} & -\end{matrix} ] \cdot [ \begin{matrix}{{{w}_{1}}^{\vert}}_{\vert} & {{{w}_{2}}^{\vert}}_{\vert} & {{{w}_{3}}^{\vert}}_{\vert}\end{matrix} ] \cdot [ \begin{matrix}{x}_{1} \\ {x}_{2} \\ {x}_{3}\end{matrix} ] + n \\ = {h}_{1} {w}_{1} {x}_{1} + {h}_{1} {w}_{2} {x}_{2} + {h}_{1} {w}_{3} {x}_{3} + n\end{matrix}$$

The expected value [symbol] is the estimate of the transmitted signal x₁ as would be received by STA-1 110-a, and can be determined as follows:

$$= \frac{{( {h}_{1} {w}_{1} )}^{*} {y}_{1}}{{\vert {h}_{1} {w}_{1} \vert}^{2}}$$

while the mean square error (MSE) can be expressed as follows:

MSE= [symbol] {(\hat{x}−x)(\hat{x}−x)*}

Thus, the mean square error can be written as follows:

$$M S E = \frac{\frac{{s}_{1}^{2}}{3} {\vert {v}_{1}^{*} {w}_{2} \vert}^{2} + \frac{{s}_{1}^{2}}{3} {\vert {v}_{1}^{*} {w}_{3} \vert}^{2} + 1}{{s}_{1}^{2} {\vert {v}_{1}^{*} {w}_{1} \vert}^{2}}$$

where s₁ is the feedback SNR value v₁* is the decompressed or decomposed beamforming feedback matrix from compressed beamforming feedback matrix V from the compressed beamforming information provided by STA-1 110-a during the channel sounding procedure. The beamforming steering matrix components (e.g., beamforming weights) w₁, w₂, and w₃ of beamforming steering matrix W are likewise determined using the beamforming information provided by STA-1 110-a, STA-2 110-b, and STA-3 110-c during the channel sounding procedure.

AP 105-a can determine an MU SINR metric as would be observed by STA-1 110-a if AP 105-a were to transmit an MU-MIMO transmission to the MU-MIMO group consisting of STA-1 110-a, STA-2 110-b, and STA-3 110-c. The MU SINR metric (SINRₑₛₜ) associated with STA-1 110-a can be determined as follows:

$$S I N {R}_{est} = \frac{𝔼 \{ {x}_{1}^{2} \}}{M S E} = \frac{\frac{{s}_{1}^{2}}{3} {\vert {v}_{1}^{*} {w}_{1} \vert}^{2}}{\frac{{s}_{1}^{2}}{3} ( {\vert {v}_{1}^{*} {w}_{2} \vert}^{2} + {\vert {v}_{1}^{*} {w}_{3} \vert}^{2} ) + 1}$$

Similar MU SINR metrics can be determined by AP 105-a as would be observed by each of STA-2 110-b and STA-3 110-c. For example, the MU SINR metric as would be observed by STA-2 110-b if AP 105-a were to transmit an MU-MIMO transmission to the MU-MIMO group consisting of STA-1 110-a, STA-2 110-b, and STA-3 110-c can be determined as follows:

$$S I N {R}_{est} = \frac{\frac{{s}_{2}^{2}}{3} {\vert {v}_{2}^{*} {w}_{2} \vert}^{2}}{\frac{{s}_{2}^{2}}{3} ( {\vert {v}_{2}^{*} {w}_{1} \vert}^{2} + {\vert {v}_{2}^{*} {w}_{3} \vert}^{2} ) + 1}$$

The MU SINR metric as would be observed by STA-3 110-c if AP 105-a were to transmit an MU-MIMO transmission to the MU-MIMO group consisting of STA-1 110-a, STA-2 110-b, and STA-3 110-c can be determined as follows:

$$S I N {R}_{est} = \frac{\frac{{s}_{3}^{2}}{3} {\vert {v}_{3}^{*} {w}_{3} \vert}^{2}}{\frac{{s}_{3}^{2}}{3} ( {\vert {v}_{3}^{*} {w}_{1} \vert}^{2} + {\vert {v}_{3}^{*} {w}_{2} \vert}^{2} ) + 1}$$

Characteristics of the disclosed equations for the MU SINR metrics (SINRₑₛₜ) and similar techniques as would be apparent to a skilled person given the benefit of the present disclosure include, but are not limited to: using beamforming weights associated with a spatial stream to other STAs (e.g., a second STA, a third STA, a fourth STA, etc.) to determine the MU SINR metric for a first STA; using interference estimates associated with spatial streams from other STAs in MU-MIMO transmission at a detriment to the MU SINR metric of a first STA; and using a single-user SNR value of a first STA with interference estimates of other STAs to determine the MU SINR metric of the first STA.

Moreover, in addition to the actual values calculated using the disclosed equations, some examples of the MU SINR metric include weightings of the various components and/or approximations as determined by AP 105-a associated with various wireless environments and/or operational conditions.

In some embodiments, AP 105-a does not calculate the beamforming steering matrix W for the purpose of analyzing candidate MU-MIMO groups. Instead, AP 105-a utilizes a default value or a historical value (e.g., derived from the same or similar STAs under like conditions) for the beamforming steering matrix W and beamforming steering matrix components w₁, w₂, and w₃. For example, AP 105-a determines that an approximation of beamforming steering matrix W can be used based at least in part on a comparison of the received compressed or non-compressed beamforming information corresponding to a present MU SINR metric determination with previously received compressed or non-compressed beamforming information. As such, the beamforming steering matrix W determined under comparable feedback information or used for actual MU-MIMO transmission of the same or similar MU-MIMO groups of STAs can be used as an approximation of beamforming steering matrix W for the MU SINR metric calculations. In yet other embodiments, AP 105-a entirely eliminates the beamforming steering matrix W and beamforming steering matrix components w₁, w₂, and w₃ from for the MU SINR metric calculations, for example, by directly using the channel feedback values, s₁v₁, s₂v₂, and s₃v₃, respectively, in their places in the described calculations. Such embodiments approximating or eliminating the beamforming steering matrix W from the MU SINR metric calculations can be used, for example, when temporary computational constraints exist within AP 105-a (e.g., in certain instances where computing an minimum mean square error (MMSE)-optimized beamforming steering matrix W is costly and/or too time intensive).

The above example represents one of many combinations of STAs 110 the AP 105-a may analyze for determining effective MU-MIMO transmission groups with which to transmit data to the number of STAs 110. In one example, AP 105-a may determine MU SINR metrics and analyze candidate MU-MIMO groups comprised of STA-2 and STA-3 as a possible MU-2 group, STA-1, STA-5, and STA-6 as a possible MU-3 group, and STA-3, STA-4, STA-5, and STA-6 as a possible MU-4 group.

In one example, AP 105-a may determine a correlation metric among the MU SINR metrics of STA-3, STA-4, STA-5, and STA-6 as the candidate MU-4 group, and may determine the MU SINR metric of STA-5 is significantly lower (e.g., by one or two standard deviations from the median of all SINR metrics of the candidate MU-4 group). As such, AP 105-a removes STA-5 from the candidate MU-4 group thereby reducing the size of the candidate MU-MIMO group to a new candidate MU-3 group. AP 105-a now determines MU SINR metrics of STA-3, STA-4, and STA-6 as the new candidate MU-3 group, and determines the MU SINR metrics of each of STA-3, STA-4, and STA-6 have increased over their respective MU SINR metrics in the former candidate MU-4 group that included STA-5. AP 110-a then blacklists STA-5 from MU-MIMO transmission groupings with any of STA-3, STA-4, and STA-6 for a predetermined period of time (e.g., 500 ms, 5 second, 30 seconds, 2 minutes, 5 minutes, etc.).

In this regard, a goal of analyzing various candidate MU-MIMO groups is to determine channel correlation patterns among the STAs 110 and identify groups of STAs 110 that exhibit good uncorrelated channel characteristics so as to form efficient MU-MIMO transmission groups. In this instance, each STA 110 in an efficient MU-MIMO transmission group exhibits a high MU SINR metric. The high MU SINR metrics of the STAs in such an efficient MU-MIMO transmission group are also correlated to high achievable high MCS rates.

In one example, AP 105-a determines MU grouping metrics (GMs) for the candidate MU-MIMO groups. A lower GM may indicate more correlation and less orthogonality between the spatial streams of MU-MIMO transmissions intended for the STAs 110 included in a candidate MU-MIMO group, and a higher GM may indicate less correlation and more orthogonality between the spatial streams of MU-MIMO transmissions intended for the STAs 110 included in a candidate MU-MIMO group. A GM may be based at least in part on an angle between channel vectors associated with different spatial streams (e.g., a first channel vector associated with a first spatial stream and a second channel vector associated with a second spatial stream) or an angle between a channel vector and a subspace (e.g., a first channel vector associated with a first spatial stream and a subspace associated with two or more additional spatial streams).

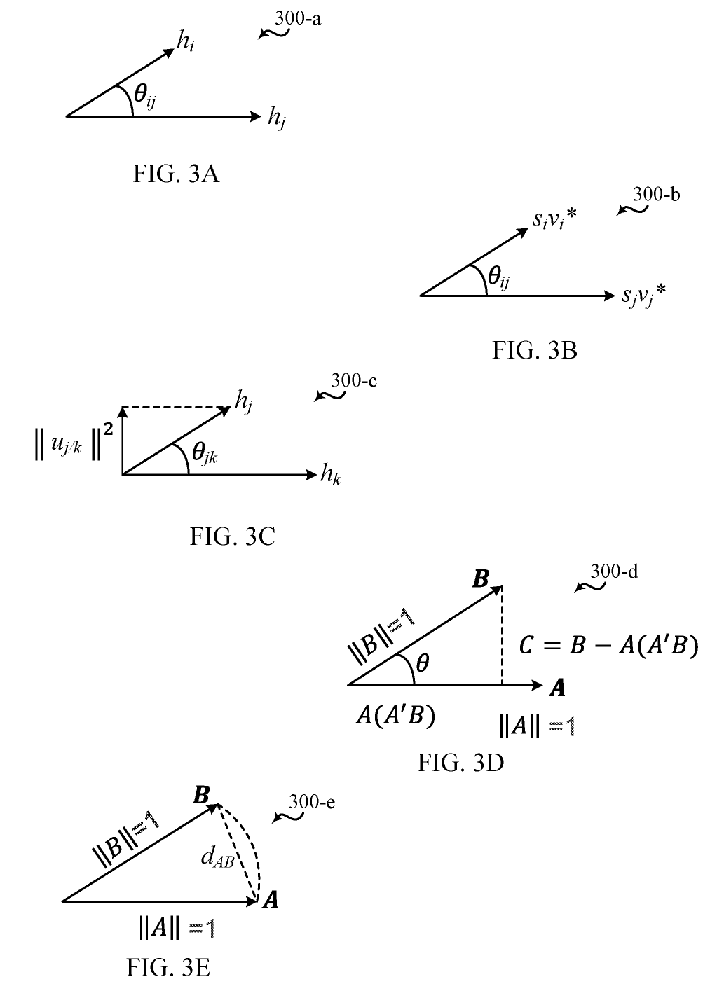

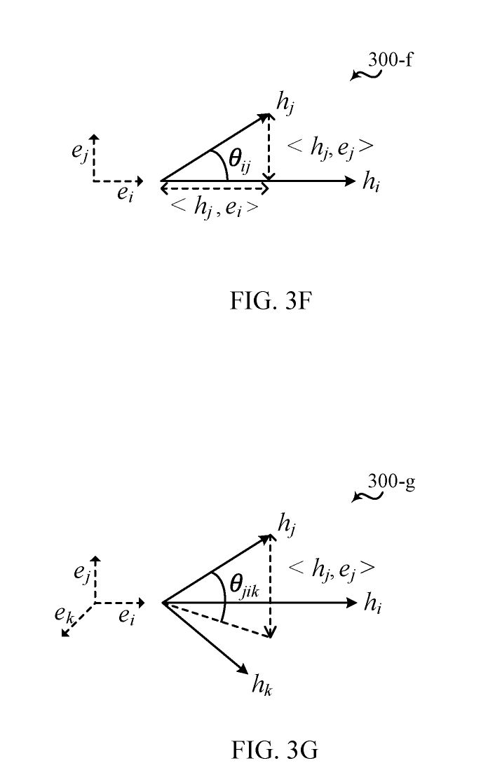

For a candidate MU-MIMO group of two STAs, where each STA or channel is associated with one spatial stream, the GM for the candidate MU-MIMO group can be determined based at least in part on an angle, θᵢⱼ, between a first channel vector, hᵢ, associated with a first spatial stream and a second channel vector, hⱼ, associated with a second spatial stream (see, e.g., the diagram 300-a of FIG. 3A). More particularly, the compatibility of grouping STA-i with STA-j, denoted GM_{i/j}, may be determined as follows:

$$G {M}_{i / j} = {sin}^{2} {θ}_{ij} = {sin}^{2} ∠ ( {h}_{i} , {h}_{j} ) = 1 - \frac{{\vert 〈 {h}_{i} , {h}_{j} 〉 \vert}^{2}}{{‖ {h}_{i} ‖}^{2} {‖ {h}_{j} ‖}^{2}} = G {M}_{j / i}$$

where |<hᵢ, hⱼ>|² is the square of the inner product of the channel vectors, and ∥hᵢ∥²∥hⱼ∥² is the product of the squared normalizations of the channel vectors. When the two STAs are aligned (e.g., when hⱼ=c*hᵢ, where c is a constant), GM_{i/j}=0. When the two STAs are orthogonal (e.g., when hⱼ⊥hᵢ), GM_{i/j}=1. In some examples, a GM is calculated per subcarrier and averaged over a plurality of subcarriers. In certain examples, the GM is averaged over all subcarriers of the received VHT CBF report information bandwidth. In other examples, to reduce complexity of the computations, the GM is averaged over a subset of subcarriers (e.g., a subset comprising every other subcarrier or a subset of subcarriers where 1 out of k subcarriers of the total bandwidth is taken such that as k increases, the computational complexity decreases).

The actual channel vectors, hᵢ and hⱼ, may be approximated as h=sv*, where s is a feedback SNR value and v* is a compressed beamforming feedback matrix received in beamforming information (e.g., a VHT CBF report) after decompression and reconstruction. See, e.g., FIG. 3B, which shows a diagram 300-b of an angle θᵢⱼ between channel vectors sᵢvᵢ* and sⱼvⱼ*. The squared normalization of a channel vector may be reduced to a square of the corresponding nonzero singular values (i.e., ∥hᵢ∥²=Σ_{i,l}², where λ_{i,l} is the l^{th} nonzero singular value for hᵢ, and L is the number of nonzero singular values). Thus, GM_{i/j} may be determined as follows:

$$G {M}_{i / j} = {sin}^{2} {θ}_{ij} = {sin}^{2} ∠ ( {s}_{i} {v}_{i}^{*} , {s}_{j} {v}_{j}^{*} ) = 1 - \frac{{\vert 〈 {s}_{i} {v}_{i}^{*} , {s}_{j} {v}_{j}^{*} 〉 \vert}^{2}}{{λ}_{i}^{2} {λ}_{j}^{2}} = G {M}_{j / i} .$$

In the present disclosure, a reference to a channel vector, h, is understood to also reference the approximation sv*.

To determine higher order GMs, lower order GMs (or intermediate GMs) may be combined. For example, for a candidate MU-MIMO group of three STAs, the compatibility of grouping STA-i with the subspace of STA-j and STA-k, denoted GM_{i/jk}, is determined as follows:

GM_{i/jk}=sin²∠(hᵢ,span{hⱼ,hₖ}).

Similarly, the compatibility of grouping STA-j with the subspace of STA-i and STA-k, denoted GM_{j/ik}, and the compatibility of grouping STA-k with the subspace of STA-i and STA-j, denoted GM_{k/ij}, are determined as follows:

GM_{j/ik}=sin²∠(hⱼ,span{hᵢ,hₖ})

GM_{k/ij}=sin²∠(hₖ,span{hᵢ,hⱼ}).

Because the values of higher order GMs for a candidate MU-MIMO group (e.g., the values GM_{i/jk}, GM_{j/ik}, and GM_{k/ij}) may not be equal, the values may be combined to form a single GM for a candidate MU-MIMO group. Examples of a single GM for the above candidate MU-MIMO group of three STAs include a sum, such as:

GMᵢⱼₖ=GM_{i/jk}+GM_{j/ik}+GM_{k/ij}

or a weighted sum that factors in the total number of spatial streams of the STAs, Nₛₛ, in the candidate MU-MIMO group, such as:

$$G {M}_{ijk} = {log}_{2} ( 1 + \frac{1}{{N}_{ss}} {‖ {h}_{i} ‖}^{2} G {M}_{i / jk} ) + {log}_{2} ( 1 + \frac{1}{{N}_{ss}} {‖ {h}_{j} ‖}^{2} G {M}_{j / ik} ) + {log}_{2} ( 1 + \frac{1}{{N}_{ss}} {‖ {h}_{k} ‖}^{2} G {M}_{k / ij} ) .$$

The grouping metric GMᵢⱼₖ provides an approximation of the PHY rate for a candidate MU-MIMO group using relatively low-complexity computations. Alternatively, an actual PHY rate for a candidate MU-MIMO group, Rᵢⱼₖ, could be calculated as follows:

$${R}_{ijk} = {log}_{2} ( 1 + \frac{{‖ {h}_{i} {w}_{i} ‖}^{2}}{1 + {‖ {h}_{i} {w}_{j} ‖}^{2} + {‖ {h}_{i} {w}_{k} ‖}^{2}} ) + {log}_{2} ( 1 + \frac{{‖ {h}_{j} {w}_{j} ‖}^{2}}{1 + {‖ {h}_{j} {w}_{i} ‖}^{2} + {‖ {h}_{j} {w}_{k} ‖}^{2}} ) + {log}_{2} ( 1 + \frac{{‖ {h}_{k} {w}_{k} ‖}^{2}}{1 + {‖ {h}_{k} {w}_{i} ‖}^{2} + {‖ {h}_{k} {w}_{j} ‖}^{2}} ) .$$

However, the calculation of Rᵢⱼₖ requires a beamforming matrix calculation based at least in part on weighting matrices, w (i.e., higher-complexity computations). It is to be appreciated that, in some implementations, the grouping metrics described herein provide a computationally inexpensive metric for estimating an SINR metric by avoiding calculations associated with a computationally-expensive weighting/precoding matrix. The SINR metric can be mapped to an MCS for a STA. In some non-limiting examples, the grouping metrics described herein provide an estimate for: correlation between the channels in a candidate MU group for determining efficient MU groupings, MU SINR for each STA in each candidate MU group, and MCS for each STA in each candidate MU group for use in dynamic rate adaptation.

For example, the MU SINR for a STA (e.g., STA i) in a candidate MU group with users j and k can be given by:

$$S I N R i / jk = \frac{1}{{N}_{ss}} {‖ {h}_{i} ‖}^{2} G {M}_{i / jk}$$

In this regard, a per-user MCS can be estimated based at least in part through a predetermined or pre-calculated Lookup Table mapping the MU SINR to a particular MCS.

Techniques such as Gram-Schmidt orthogonalization, MATLAB calculations, chordal distance calculations, or QR decomposition calculations may be used to determine a GM for a candidate MU-MIMO group of more than two STAs. For example, Gram-Schmidt orthogonalization may be used to derive an angle, θᵢⱼ, between a channel vector (or more generally, a channel vector subspace) and the orthogonal complement of the subspace spanned by other channel vectors. Using Gram-Schmidt orthogonalization, the value of GM_{i/jk} may be determined by determining the orthogonal complement of projecting hⱼ on hₖ (i.e., u_{j/k}), as shown in the diagram 300-c of FIG. 3C; determining the squared normalization of u_{i/j} (i.e. ∥u_{i/k}∥²); using u_{j/k} and ∥u_{j/k}∥² to determine the orthogonal complement of projecting hᵢ on the subspace of hⱼ on hₖ (i.e., u_{i/jk}); and determining the squared normalization of u_{i/jk} (i.e., ∥u_{i/jk}∥²) to determine GM_{i/jk}:

$${u}_{j / k} = {h}_{j} - < {h}_{j} , {h}_{k} > \frac{{h}_{k}}{{‖ {h}_{k} ‖}^{2}}$$

$${‖ {u}_{j / k} ‖}^{2} = {‖ {h}_{j} ‖}^{2} {GM}_{j / k}$$

$$\begin{matrix}{u}_{i / jk} = {h}_{i} - < {h}_{i} , {u}_{j / k} > \frac{{u}_{j / k}}{{‖ {u}_{j / k} ‖}^{2}} - < {h}_{i} , {h}_{k} > \frac{{h}_{k}}{{‖ {h}_{k} ‖}^{2}} = {u}_{i / jk} \\ = {h}_{i} - ( < {h}_{i} , {h}_{j} > - < {h}_{j} , {h}_{k} > \frac{< {h}_{i} , {h}_{k} >}{{‖ {h}_{k} ‖}^{2}} ) \\ \frac{{h}_{j} - < {h}_{j} , {h}_{k} > \frac{{h}_{k}}{{‖ {h}_{k} ‖}^{2}}}{{‖ {h}_{j} ‖}^{2} {GM}_{j / k}}\end{matrix} \\ < {h}_{i} , {h}_{k} > \frac{{h}_{k}}{{‖ {h}_{k} ‖}^{2}}$$

$${‖ {u}_{i / jk} ‖}^{2} = {‖ {h}_{i} ‖}^{2} {GM}_{i / jk} .$$

For a candidate MU-MIMO group of four STAs, Gram-Schmidt orthogonalization may be used to determine a value of GM_{i/jkl} as follows:

$${‖ {u}_{i / jkl} ‖}^{2} = {‖ {h}_{i} ‖}^{2} {GM}_{i / jkl}$$

$$where$$

$${u}_{i / jkl} = {h}_{i} - < {h}_{i} , {u}_{j / kl} > \frac{{u}_{j / kl}}{{‖ {u}_{j / kl} ‖}^{2}} - < {h}_{i} , {u}_{k / l} > \frac{{u}_{k / l}}{{‖ {u}_{k / l} ‖}^{2}} - < {h}_{i} , {h}_{l} > \frac{{h}_{l}}{{‖ {h}_{l} ‖}^{2}}$$

$$and$$

$${u}_{j / kl} = {h}_{j} - ( < {h}_{j} , {h}_{k} > - < {h}_{k} , {h}_{l} > \frac{< {h}_{j} , {h}_{l} >}{{‖ {h}_{l} ‖}^{2}} ) \frac{{h}_{k} - < {h}_{k} , {h}_{l} > \frac{{h}_{l}}{{‖ {h}_{l} ‖}^{2}}}{{‖ {h}_{k} ‖}^{2} {GM}_{k / l}} - < {h}_{j} , {h}_{l} > \frac{{h}_{l}}{{‖ {h}_{l} ‖}^{2}}$$

$$and$$

$${u}_{k / l} = {h}_{k} - < {h}_{k} , {h}_{l} > \frac{{h}_{l}}{{‖ {h}_{l} ‖}^{2}} .$$

Similar Gram-Schmidt orthogonalization operations may be performed for higher order GMs.

The above Gram-Schmidt orthogonalization examples assume each STA is associated with a single spatial stream. However, a STA may in some cases be associated with multiple spatial streams (e.g., a STA may be a multiple-spatial stream STA). GMs for a candidate MU-MIMO group including STA-A and STA-B, where STA-B is a multiple-spatial stream STA, may be computed by representing STA-B as multiple distinct single-spatial stream STAs. GM_{A/B} may therefore be determined similarly to GM_{i/jk}, using the angle between h_{A} and the subspace formed by the two channel vectors of STA-B (i.e., by projecting the channel vector h_{A} on a subspace of channel vectors h_{B1} and h_{B2}). GM_{B/A} may not be computed similarly to GM_{i/jk}, because it would involve projecting a subspace onto a channel vector. However, GM_{B/A} may be determined by calculating GM_{B1/A} and GM_{B2/A}, based at least in part on h_{B1} and h_{B2} respectively. GM_{B/A} may then be computed as an average or minimum of GM_{B1/A} and GM_{B2/A}, using one of the following equations:

GM_{B/A}=½(GM_{B1/A}+GM_{B2/A})

GM_{B/A}=min(GM_{B1/A},GM_{B2/A}).

Computing GM_{B/A} as a minimum of GM_{B1/A} and GM_{B2/A} can avoid skewing GM_{B/A} too high when one of GM_{B1/A} and GM_{B2/A} is high and the other is low.

When a STA is associated with multiple spatial streams, an angle may be determined between a spatial stream associated with one STA (e.g., STA-A) and each of the spatial streams associated with the other STA (e.g., STA-B), similarly to the scenario in which GMs are computed for pairs of three STAs or channels. It is to be appreciated that the Gram Schmidt method and variations thereof do not require SVD operations. Thus, in some implementations, determining GMs and other associated metrics (e.g., MU SINR) utilize the Gram Schmidt methods described herein.

As another option for determining a GM for a candidate MU-MIMO group of more than two STAs, MATLAB calculations may be used to derive an angle, θ, between two vector subspaces, A₁ and B₁, where:

[A,S,V]=orth(A₁)

[B,S,V]=orth(B₁)

The above orth( ) operation in the MATLAB approach involves performing SVD operation and taking the first m columns of U corresponding to m nonzero singular values. The determination of these grouping metrics using MATLAB operations therefore includes the performance of at least two SVD operations. As such, the MATLAB approach is a computationally-expensive approach to determining grouping metrics.

From the vectors A and B, the projection of vector B on vector A may be computed as:

C=B−A(A′B)

and the value of sin θ may be determined as:

sin(θ)=min(1,∥C∥)

See, e.g., the diagram 300-d of FIG. 3D. The value of GM_{A/B} may then be determined as:

GM_{A/B}=sin(θ)²

By way of example, a value of GM_{i/jkl} may be determined from the two subspaces A₁ and B₁ by setting:

A₁=hᵢ

B₁=[hⱼhₖhₗ]

where the channel vectors hⱼ, hₖ, and hᵢ are column vectors in the B₁ subspace.

As another option for determining a GM for a candidate MU-MIMO group of more than two STAs, chordal distance calculations may be used to determine a chordal distance, d_{AB}, between the two vectors A and B (see, e.g., the diagram 300-e of FIG. 3E), where:

$${d}_{AB} = \frac{1}{\sqrt{2}} {‖ {AA}^{H} - {BB}^{H} ‖}_{F}$$

with ∥AA^{H}−BB^{H}∥_{F} being a Frobenius norm. The value of GM_{A/B} may be determined as:

GM_{A/B}=d_{AB}²

By way of example, a value of GM_{i/jkl} may be determined from the two subspaces A₁ and B₁ by setting:

A₁=hᵢ

B₁=[hⱼhₖhₗ]

As the channel vectors become more correlated, the chordal distance between the vectors A and B decreases. The determination of each of these grouping metrics using chordal distance calculations includes the performance of at least one SVD operation.

In another option, a GM for a candidate MU-MIMO group of two or more STAs is determined by QR decomposition calculations. For example, the channel matrix is decomposed into a Q matrix and an R matrix (i.e., the channel matrix is a product of matrices Q and R). The column vectors in the Q matrix are the orthonormal basis of the column vectors in the original channel matrix, whereas the R matrix is an upper triangular matrix. In some cases, the Q matrix can be determined using Gram-Schmidt orthogonalization techniques. Using a QR decomposition approach, the values of GM_{j/i} and GM_{j/ik} are calculated by determining normalized projection vectors (e.g., e₁, e₂, . . . , eₙ) where each normalized projection vector consists of all zeros except for the i^{th} entry, which is one. A projection vector (e.g., uᵢ, u_{j/i}, etc.) is normalized by dividing the projection vector by the projection vector's square norm to obtain a unity-normalized vector in the direction of the projection vector.

By way of example, the value of GM_{j/i} is determined by equating channel vector hᵢ as projection vector uᵢ. The normalized projection vector, eᵢ, for QR decomposition is determined as:

$${e}_{i} = \frac{{u}_{i}}{{‖ {u}_{i} ‖}^{2}}$$

In this regard, the normalized projection vector, eᵢ, is a unity-normalized vector in the direction of projection vector uᵢ. The orthogonal complement of projecting hⱼ on hᵢ (i.e., u_{j/i}) can be calculated as:

$${u}_{j / i} = {h}_{j} - < {h}_{j} , {u}_{i} > \frac{{u}_{i}}{{‖ {u}_{i} ‖}^{2}}$$

The normalized projection vector, eⱼ, for QR decomposition is determined as:

$${e}_{j} = \frac{{u}_{j / i}}{{‖ {u}_{j / i} ‖}^{2}}$$

In the QR decomposition approach, the value of GM_{j/i} is determined based at least in part on solving for R matrix when the vectors in the Q matrix are set to the normalized projection vectors, eᵢ and eⱼ, so that the product of matrices Q and R is equal to the channel matrix A having channel vectors hᵢ and hⱼ, as shown in the diagram 300-f of FIG. 3F. The value of GM_{j/i} is determined using the QR decomposition approach as follows:

$$A = [ {h}_{i} {h}_{j} ] and [ QR ] = qr ( A ) , \\ Q = [ {e}_{i} {e}_{j} ] and R = [ \begin{matrix}< {h}_{i} , {e}_{i} > & < {h}_{j} , {e}_{i} > \\ 0 & < {h}_{j} , {e}_{j} >\end{matrix} ] .$$

The lower rightmost vector component (i.e., <hⱼ, eⱼ>) of the main diagonal of the upper triangular matrix R is used in calculating the grouping metric as follows:

$${GM}_{j / i} = \frac{{\vert < {h}_{j} , {e}_{j} > \vert}^{2}}{{‖ {h}_{j} ‖}^{2}} = \frac{{\vert R ( {N}_{ss} , {N}_{ss} ) \vert}^{2}}{{‖ {h}_{j} ‖}^{2}}$$

where the inner product of the channel vector hⱼ and normalized projection vector eⱼ is expressed as <hⱼ, eⱼ>=hⱼeⱼ′, where eⱼ′ is the complex conjugate of the normalized projection vector eⱼ.

In an additional example, the value of GM_{j/ik} is determined by equating channel vector hᵢ as projection vector uᵢ. The normalized projection vector, eᵢ, for QR decomposition is determined as:

$${e}_{i} = \frac{{u}_{i}}{{‖ {u}_{i} ‖}^{2}}$$

The orthogonal complement of projecting hₖ on hᵢ (i.e., u_{k/i}) can be calculated as:

$${u}_{k / i} = {h}_{k} - < {h}_{k} , {h}_{i} > \frac{{u}_{i}}{{‖ {u}_{i} ‖}^{2}}$$

The normalized projection vector, eₖ, for QR decomposition is determined as:

$${e}_{j} = \frac{{u}_{k / i}}{{‖ {u}_{k / i} ‖}^{2}}$$

The orthogonal complement of projecting hⱼ on the subspace spanning vectors hᵢ and hₖ (i.e., u_{j/ik}) can be calculated as:

$${u}_{j / ki} = {h}_{j} - < {h}_{j} , {u}_{k / i} > \frac{{u}_{k / i}}{{‖ {u}_{k / i} ‖}^{2}} - < {h}_{j} , {u}_{i} > \frac{{u}_{i}}{{‖ {u}_{i} ‖}^{2}}$$

The normalized projection vector, eⱼ, for QR decomposition is determined as:

$${e}_{j} = \frac{{u}_{j / ki}}{{‖ {u}_{j / ki} ‖}^{2}}$$

The value of GM_{j/ki} is similarly determined based at least in part on solving for R matrix when the vectors in the Q matrix are set to the normalized projection vectors, eᵢ, eₖ, and eⱼ, so that the product of matrices Q and R is equal to the channel matrix A having channel vectors hᵢ, hₖ, and hⱼ, as shown in the diagram 300-g of FIG. 3G. The value of GM_{j/ki} is determined using the QR decomposition approach as follows:

$$A = [ {h}_{i} {h}_{k} {h}_{j} ] and [ QR ] = qr ( A ) , \\ Q = [ {e}_{i} {e}_{k} {e}_{j} ] and R = [ \begin{matrix}< {h}_{i} , {e}_{i} > & < {h}_{k} , {e}_{i} > & < {h}_{j} , {e}_{i} > \\ 0 & < {h}_{k} , {e}_{k} > & < {h}_{j} , {e}_{k} > \\ 0 & 0 & < {h}_{j} , {e}_{j} >\end{matrix} ] .$$

The lower rightmost vector component (i.e., <hᵢ, eⱼ>) of the main diagonal of the upper triangular matrix R is used in calculating the grouping metric as follows:

$${GM}_{j / ki} = \frac{{\vert < {h}_{j} , {e}_{j} > \vert}^{2}}{{‖ {h}_{j} ‖}^{2}} = \frac{{\vert R ( {N}_{ss} , {N}_{ss} ) \vert}^{2}}{{‖ {h}_{j} ‖}^{2}}$$

where the inner product of the channel vector hⱼ and normalized projection vector eⱼ is expressed as <hⱼ, eⱼ>=hⱼeⱼ′, where eⱼ′ is the complex conjugate of the normalized projection vector eⱼ.

The above QR decomposition approach is provided as non-limiting example. Various QR decomposition approaches given the benefit of the present disclosure can be used to calculate GMs for various MU group size (e.g., GM_{i/j}, GM_{i/jk}, GM_{i/jkl}, etc.). Moreover, it is to be appreciated that the QR decomposition approach and variations thereof do not require SVD operations.

In some examples, the computation of higher order GMs can be simplified based at least in part on intermediate GMs (e.g., at least two pairwise GMs or lower order GMs). For example, a higher order GM can be computed as a minimum of a set of pairwise GMs or lower order GMs associated with the higher order GM, as follows:

GMᵢⱼₖ=min(GMᵢⱼ,GMᵢₖ,GMⱼₖ)

GMᵢⱼₖₗ=min(GMᵢⱼₖ,GMᵢⱼₗ,GMⱼₖₗ,GMᵢₖₗ)

GMᵢⱼₖₗ=min(GMᵢⱼ,GMᵢₖ,GMᵢₗ,GMⱼₖ,GMₖₗ)

The above simplification technique may in some cases be limited to GMs at or above a certain order (e.g., GMs corresponding to candidate MU-MIMO groups of five or more STAs or channels).

The AP 105-a may in some cases determine a plurality of GMs of one or more orders and identify a perceived optimal MU-MIMO group for each order. For example, the AP 105-a may identify a perceived optimal MU-2 group, MU-3 group, and so on. For a set of M STAs, the number of candidate MU-MIMO groups from which optimal MU-MIMO groups of different order may be identified is Σₘ₌₂^{M} Cₘ^{M}. For a set of 8 STAs, the number of candidate MU-MIMO groups is 247 (plus eight SU groups). The computation of a GM for each of these candidate MU-MIMO groups can use significant resources and power and result in significant processing delays.

To reduce the number of GMs that are determined, the AP 105-a may determine first-level grouping metrics (GMs) associated with a first set of candidate MU-MIMO groups, and select a first subset of the first set of candidate MU-MIMO groups based at least in part on the first-level grouping metrics. The AP 105-a may identify a second set of candidate MU-MIMO groups based at least in part on the first subset of candidate MU-MIMO groups, and determine second-level grouping metrics associated with the second set of candidate MU-MIMO groups. Each candidate MU-MIMO group in the second set of candidate MU-MIMO groups may include a greater number of STAs or channel vectors than each candidate MU-MIMO group in the first set of candidate MU-MIMO groups. Within each selected subset of candidate MU-MIMO groups (e.g., the first subset, the second subset, etc.), a candidate MU-MIMO group of the subset may be identified as an optimal MU group. In this manner, an optimal MU2 group, optimal MU3 group, etc. may be identified (or selected). The technique described in this paragraph may be referred to as a tree-based selection technique.

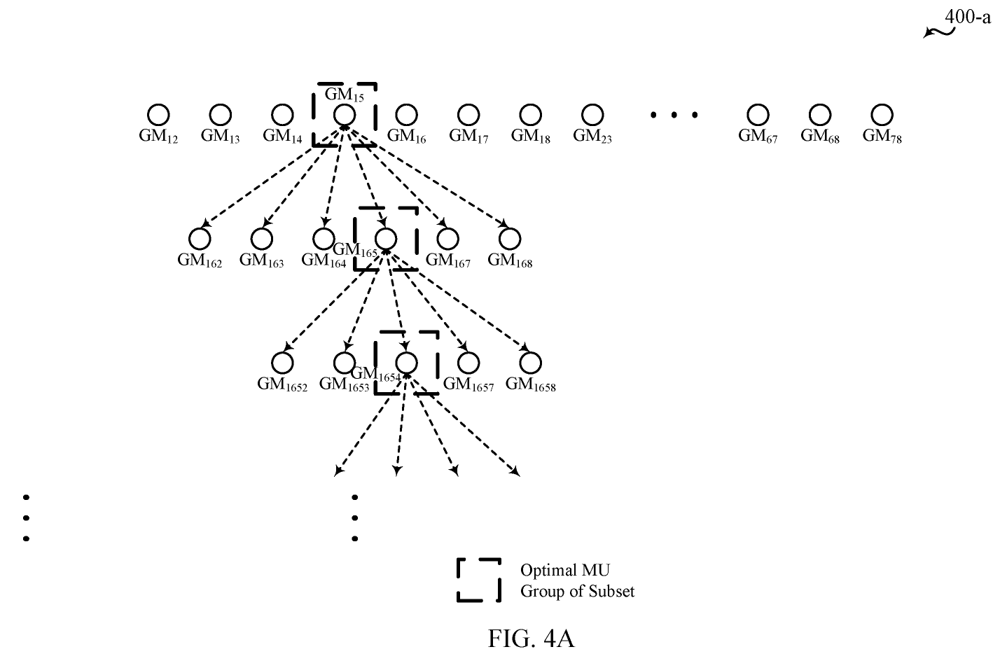

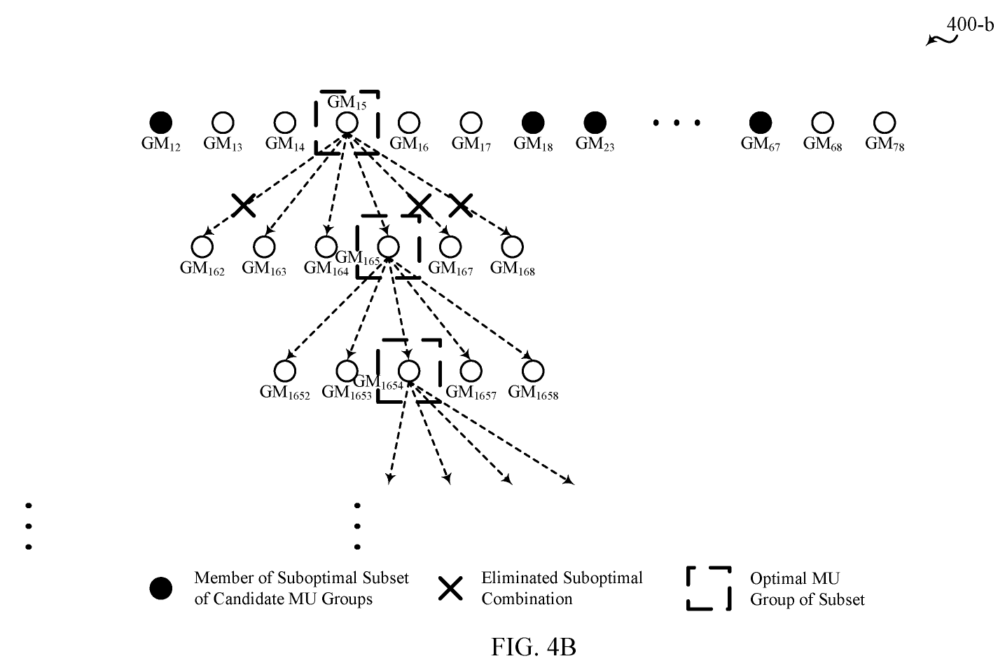

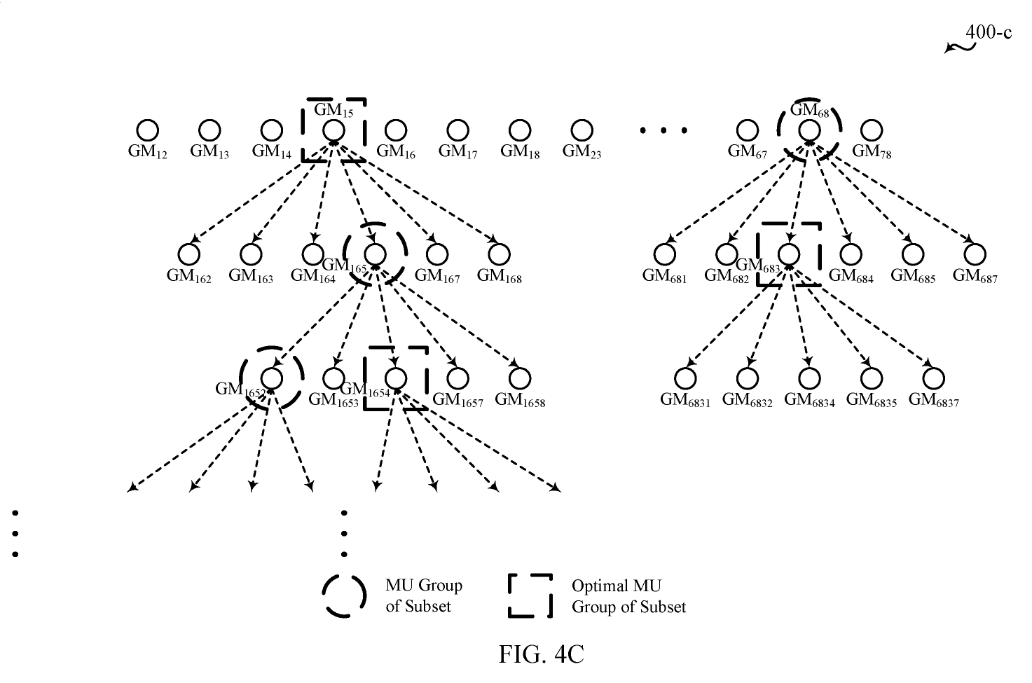

FIG. 4A shows an example candidate MU-MIMO group selection tree 400 illustrating a first tree-based selection technique in accordance with various aspects of the present disclosure. The first tree-based selection technique can be performed by a communication device (e.g., an AP 105) in communication with a plurality of other communication devices (e.g., STAs 110). The AP 105 and STAs 110 can be examples of the AP 105 and STAs of FIGS. 1 and 2.

In FIG. 4A, the first set of candidate MU-MIMO groups includes all candidate groups of two STAs or streams, where the number of STAs or channels, M, is eight, for example. The number of candidate MU-MIMO groups in the first set of candidate MU-MIMO groups is 28. First-level grouping metrics (GMs) are determined for each of the candidate MU-MIMO groups in the first set of candidate MU-MIMO groups, and a first subset of the first set of candidate MU-MIMO groups is selected based at least in part on the first-level grouping metrics. By way of example, the first subset of the first set of candidate MU-MIMO groups is shown to include a first candidate MU-MIMO group (STA-1 and STA-6, or channels 1 and 6) associated with a greatest first-level grouping metric (e.g., a first-level grouping metric, GM₁₆, indicating the greatest orthogonality between the members of a candidate MU-MIMO group in the first set of candidate MU-MIMO groups). The first candidate MU-MIMO group may be identified as an optimal MU-2 group. In some examples, a suboptimal subset of candidate MU-MIMO groups can be identified, and used to prune the selection tree shown in FIG. 4A, as described with reference to FIG. 4B.

A second set of candidate MU-MIMO groups includes the STA or channel of the first candidate MU-MIMO group in combination with each of the STAs or channels not included in the first candidate MU-MIMO group (e.g., a set of M−2 candidate MU-MIMO groups, or six candidate MU-MIMO groups when M=8). Second-level grouping metrics (GMs) are determined for each of the candidate MU-MIMO groups in the second set of candidate MU-MIMO groups, and a second subset of the second set of candidate MU-MIMO groups is selected based at least in part on the second-level grouping metrics. By way of example, the second subset of the second set of candidate MU-MIMO groups is shown to include a second candidate MU-MIMO group (STA-1, STA-6, and STA-5, or channels 1, 6, and 5) associated with a greatest second-level grouping metric (e.g., a second-level grouping metric, GM₁₆₅, indicating the greatest orthogonality between the members of a candidate MU-MIMO group in the second set of candidate MU-MIMO groups). The second candidate MU-MIMO group may be identified as an optimal MU-3 group.

A third set of candidate MU-MIMO groups includes the STA or channel of the second candidate MU-MIMO group in combination with each of the STAs or channels not included in the second candidate MU-MIMO group (a set of five candidate MU-MIMO groups). Third-level grouping metrics (GMs) are determined for each of the candidate MU-MIMO groups in the third set of candidate MU-MIMO groups, and a third subset of the third set of candidate MU-MIMO groups is selected based at least in part on the third-level grouping metrics. By way of example, the third subset of the third set of candidate MU-MIMO groups is shown to include a third candidate MU-MIMO group associated with a greatest third-level grouping metric (e.g., a third-level grouping metric, GM₁₆₅₄, indicating the greatest orthogonality between the members of a candidate MU-MIMO group in the third set of candidate MU-MIMO groups). The third candidate MU-MIMO group may be identified as an optimal MU-4 group.

The tree-based selection technique illustrated in FIG. 4A may continue until an optimal MUM group is selected (e.g., an optimal MU-8 group, when M=8), or may be terminated when none of the grouping metric associated with a set of candidate MU-MIMO groups satisfies a minimum GM threshold (e.g., because identifying an optimal MU group not associated with the minimum GM may lead to high cross-STA (or cross-channel) interference). When the tree-based selection technique illustrated in FIG. 4A is extended to selection of an optimal MUM group, the optimal groups may be identified after determining 49 grouping metrics out of the possible 247 grouping metrics. Stated more generally, the tree-based selection technique illustrated in FIG. 4A may reduce the number of grouping metrics that need to be determined from Σₘ₌₂^{M} Cₘ^{M} to C₂^{M}+Σₘ₌₂^{M-1}M−m.

FIG. 4B shows an example candidate MU-MIMO group selection tree 400-b illustrating a second tree-based selection technique in accordance with various aspects of the present disclosure. The second tree-based selection technique can be performed by a communication device (e.g., an AP 105) in communication with a plurality of other communication devices (e.g., STAs 110). The AP 105 and STAs 110 can be examples of the AP 105 and STAs of FIGS. 1 and 2.

In FIG. 4B, the first set of candidate MU-MIMO groups includes all candidate groups of two STAs or channels, where the number of STAs or channels, M, is eight, for example. The number of candidate MU-MIMO groups in the first set of candidate MU-MIMO groups is 28. First-level grouping metrics (GMs) are determined for each of the candidate MU-MIMO groups in the first set of candidate MU-MIMO groups, and a first subset of the first set of candidate MU-MIMO groups is selected based at least in part on the first-level grouping metrics. By way of example, the first subset of the first set of candidate MU-MIMO groups is shown to include a first candidate MU-MIMO group (a candidate MU-MIMO group including STA-1 and STA-6, or channels 1 and 6) associated with a greatest first-level grouping metric (e.g., a first-level grouping metric, GM₁₆, indicating the greatest orthogonality between the members of a candidate MU-MIMO group in the first set of candidate MU-MIMO groups). The first candidate MU-MIMO group may be identified as an optimal MU-2 group. In addition to identifying the first candidate MU-MIMO group, a suboptimal subset of candidate MU-MIMO groups is identified. Each candidate MU-MIMO group in the suboptimal subset of candidate MU-MIMO groups is associated with a first-level grouping metric below a threshold.

A second set of candidate MU-MIMO groups includes the STA or channel of the first candidate MU-MIMO group in combination with each of the STAs or channels not included in the first candidate MU-MIMO group (e.g., a set of M−2 candidate MU-MIMO groups, or six candidate MU-MIMO groups when M=8), less any candidate MU-MIMO group including the STAs or channels of a candidate MU-MIMO group in the suboptimal subset of candidate MU-MIMO groups (i.e., potential candidate MU-MIMO groups may be eliminated). In the example of FIG. 4B, this reduces the size of the second set of candidate MU-MIMO groups from six to three, thereby reducing the number of grouping metrics that need to be determined. Second-level grouping metrics (GMs) are determined for each of the candidate MU-MIMO groups in the second set of candidate MU-MIMO groups, and a second subset of the second set of candidate MU-MIMO groups is selected based at least in part on the second-level grouping metrics. By way of example, the second subset of the second set of candidate MU-MIMO groups is shown to include a second candidate MU-MIMO group (STA-1, STA-6, and STA-5, or channels 1, 6, and 5) associated with a greatest second-level grouping metric (e.g., a second-level grouping metric, GM₁₆₅, indicating the greatest orthogonality between the members of a candidate MU-MIMO group in the second set of candidate MU-MIMO groups). The second candidate MU-MIMO group may be identified as an optimal MU3 group.

A third set of candidate MU-MIMO groups includes the STA or channel of the second candidate MU-MIMO group in combination with each of the STAs or channels not included in the second candidate MU-MIMO group (a set of five candidate MU-MIMO groups), less any candidate MU-MIMO group including the STAs or channels of a candidate MU-MIMO group in the suboptimal subset of candidate MU-MIMO groups. In the example of FIG. 4B, this reduces the size of the second set of candidate MU-MIMO groups from five to two, thereby reducing the number of grouping metrics that need to be determined. Third-level grouping metrics (GMs) are determined for each of the candidate MU-MIMO groups in the third set of candidate MU-MIMO groups, and a third subset of the third set of candidate MU-MIMO groups is selected based at least in part on the third-level grouping metrics. By way of example, the third subset of the third set of candidate MU-MIMO groups is shown to include a third candidate MU-MIMO group associated with a greatest third-level grouping metric (e.g., a third-level grouping metric, GM₁₆₅₄, indicating the greatest orthogonality between the members of a candidate MU-MIMO group in the third set of candidate MU-MIMO groups). The third candidate MU-MIMO group may be identified as an optimal MU-4 group.

The tree-based selection technique illustrated in FIG. 4B may continue until an optimal MUM group is selected (e.g., an optimal MU-8 group when M=8), or may be terminated when none of the grouping metric associated with a set of candidate MU-MIMO groups satisfies a minimum GM threshold. When the tree-based selection technique illustrated in FIG. 4B is extended to selection of an optimal MUM group, the optimal groups may be identified after determining 37-43 grouping metrics out of the possible 247 grouping metrics.

FIG. 4C shows an example candidate MU-MIMO group selection tree 400 illustrating a third tree-based selection technique in accordance with various aspects of the present disclosure. The third tree-based selection technique can be performed by a communication device (e.g., an AP 105) in communication with a plurality of other communication devices (e.g., STAs 110). The AP 105 and STAs 110 can be examples of the AP 105 and STAs of FIGS. 1 and 2.

In FIG. 4C, the first set of candidate MU-MIMO groups includes all candidate groups of two STAs or channels, where the number of STAs or channels, M, is eight, for example. The number of candidate MU-MIMO groups in the first set of candidate MU-MIMO groups is 28. First-level grouping metrics (GMs) are determined for each of the candidate MU-MIMO groups in the first set of candidate MU-MIMO groups, and a first subset of the first set of candidate MU-MIMO groups is selected based at least in part on the first-level grouping metrics. By way of example, the first subset of the first set of candidate MU-MIMO groups is shown to include multiple candidate MU-MIMO groups (e.g., candidate MU-MIMO groups associated with grouping metrics GM₁₆ and GM₆₈). The multiple candidate MU-MIMO groups may include, for example, a predetermined number, p, of candidate MU-MIMO groups associated with first-level grouping metrics indicating the greatest orthogonality between the members of the candidate MU-MIMO groups, or all candidate MU-MIMO groups associated with first-level grouping metrics above a threshold. An optimal MU-2 group (e.g., an MU candidate group associated with a grouping metric indicating the greatest orthogonality between the members of the candidate MU-MIMO group) is identified from among the candidate MU-MIMO groups of the first subset. In some examples, a suboptimal subset of candidate MU-MIMO groups can be identified, and used to prune the selection tree shown in FIG. 4C, as described with reference to FIG. 4B.

A second set of candidate MU-MIMO groups includes, for each of the candidate MU-MIMO groups in the first subset, the STAs or channels of the candidate MU-MIMO group in combination with each of the STAs or channels not included in the candidate MU-MIMO group (e.g., a set of p*(M−2) candidate MU-MIMO groups, or twelve candidate MU-MIMO groups when M=8 and p=2). Second-level grouping metrics (GMs) are determined for each of the candidate MU-MIMO groups in the second set of candidate MU-MIMO groups, and a second subset of the second set of candidate MU-MIMO groups is selected based at least in part on the second-level grouping metrics. By way of example, the second subset of the second set of candidate MU-MIMO groups is shown to include multiple candidate MU-MIMO groups (e.g., candidate MU-MIMO groups associated with grouping metrics GM₁₆₅ and GM₆₈₃). The multiple candidate MU-MIMO groups may include, for example, a predetermined number of candidate MU-MIMO groups associated with second-level grouping metrics indicating the greatest orthogonality between the members of the candidate MU-MIMO groups, or all candidate MU-MIMO groups associated with second-level grouping metrics above a threshold. An optimal MU-3 group (e.g., an MU candidate group associated with a grouping metric indicating the greatest orthogonality between the members of the candidate MU-MIMO group) is identified from among the candidate MU-MIMO groups of the second subset.

A third set of candidate MU-MIMO groups includes, for each of the candidate MU-MIMO groups in the second subset, the STAs or channels of the candidate MU-MIMO group in combination with each of the STAs or channels not included in the candidate MU-MIMO group (e.g., a set of p*(M−3) candidate MU-MIMO groups, or ten candidate MU-MIMO groups when M=8 and p=2). Third-level grouping metrics (GMs) are determined for each of the candidate MU-MIMO groups in the third set of candidate MU-MIMO groups, and a third subset of the third set of candidate MU-MIMO groups is selected based at least in part on the third-level grouping metrics. By way of example, the third subset of the third set of candidate MU-MIMO groups is shown to include multiple candidate MU-MIMO groups (e.g., candidate MU-MIMO groups associated with grouping metrics GM₁₆₅₂ and GM₁₆₅₄). The multiple candidate MU-MIMO groups may include, for example, a predetermined number of candidate MU-MIMO groups associated with third-level grouping metrics indicating the greatest orthogonality between the members of the candidate MU-MIMO groups, or all candidate MU-MIMO groups associated with third-level grouping metrics above a threshold. An optimal MU-4 group (e.g., an MU candidate group associated with a grouping metric indicating the greatest orthogonality between the members of the candidate MU-MIMO group) is identified from among the candidate MU-MIMO groups of the third subset.

The tree-based selection technique illustrated in FIG. 4C may continue until an optimal MUM group is selected (e.g., an optimal MU-8 group when M=8), or may be terminated when none of the grouping metric associated with a set of candidate MU-MIMO groups satisfies a minimum GM threshold. When the tree-based selection technique illustrated in FIG. 4C is extended to selection of an optimal MUM group, the optimal groups may be identified after determining 70 grouping metrics out of the possible 247 grouping metrics.

When the STAs referenced in FIGS. 4A-4C are STAs associated with single spatial streams (i.e., 1 ss STAs), Gram-Schmidt orthogonalization may be used to determine the needed grouping metrics. When the STAs include one or more multiple-spatial stream STAs (e.g., a 2 ss STA), each multiple-spatial stream STA may be represented as a plurality of distinct 1 ss STAs, and a GM may be determined for each of the 1 ss STAs (e.g., GM(h_{A}, h_{B1}), GM(h_{A}, h_{B2}), etc.). The 1 ss STAs representing the multiple-spatial stream STA may then be treated separately when applying the tree-based selection techniques of FIGS. 4A-4C. Alternatively, a GM may be determined for the multiple-spatial stream STA by, for example, averaging GM(h_{A}, h_{B1}), GM(h_{A}, h_{B2}), etc. When treating the 1 ss STAs separately when applying a tree-based selection technique, the tree-based selection technique may determine whether a multiple-spatial stream STA should receive on all of its spatial streams or a subset of its spatial streams. When determining a GM for the multiple-spatial stream STA and applying a tree-based selection technique using the multiple-spatial stream STA GM, the tree-based selection technique is confined to using the full spatial stream capacity of the multiple-spatial stream STA.

In some examples, a lower complexity technique, such as Gram-Schmidt orthogonalization, may be used to determine grouping metrics of lower order (e.g., pairwise grouping metrics), and a higher complexity (but possibly more accurate) technique may be used to determine grouping metrics of higher order.

In some examples, the tree-based selection techniques described with reference to FIGS. 4A-4C may be based at least in part on previous values of the grouping metrics (e.g., grouping metrics that were previously determined (in time) for a first selection of optimal MU groups and reused for a subsequent (or additional) selection of optimal MU groups at a later (or subsequent) time). In some examples, just first-level grouping metrics are reused.

FIG. 5 shows a flow chart that illustrates an example of a method 500 for phased determination of channel-correlation based grouping metrics for MU transmissions in accordance with various aspects of the present disclosure. Method 500 may be performed by any of the APs 105 or STAs 110 discussed in the present disclosure, but for clarity, method 500 will be described from the perspective of an AP 105 of FIG. 1 that sequentially receives beamforming information from a plurality of STAs 110 of FIG. 1. In some examples, AP 105 may sequentially receive beamforming information from a plurality of STAs 110, as described with reference to FIG. 2. It is to be understood that method 500 is just one example of techniques for determining channel-correlation based grouping metrics for MU transmission in a phased manner (e.g., in multiple phases), and the operations of method 500 may be rearranged, performed by other devices and component thereof, and/or otherwise modified such that other implementations are possible.

Prior to 505, AP 105 may begin sequentially receiving beamforming information (e.g., CBFs) for a channel from a plurality of STAs 110. In some examples, the beamforming information may be sequentially received as described with reference to FIG. 2. At 505, AP 105 may determine whether all of a first portion of beamforming information has been received. For example, AP 105 may determine whether beamforming information has been received from M−m₁ of the STAs. M may be a total number of STAs from which beamforming information will be received, and m₁ may have a value of 1 to M−2. If AP 105 has not received beamforming information from the M−m₁ STAs, AP 105 may make the determination at 505 again; otherwise, the method 500 may continue at 510.

At 510, AP 105 may calculate (determine) a first set of pairwise GMs (e.g., C₂^{M-m}^{₁} pairwise GMs). For example, if m₁=1 and M=8, AP 105 may calculate C₂⁷=21 pairwise GMs after receiving beamforming information from a set of 7 STAs. In some examples, m₁ may be determined based on the time needed to calculate the first set of pairwise GMs before receiving all of a second portion of beamforming information (or all of the beamforming information).

At 515, AP 105 may determine whether all of a second portion of beamforming information has been received, in addition to all of the first portion of beamforming information. For example, AP 105 may determine whether beamforming information has been received from all M STAs. If AP 105 has not received beamforming information from all M STAs, AP 105 may make the determination at 515 again; otherwise, the method 500 may continue at 520.

At 520, AP 105 may calculate a second set of pairwise GMs (e.g., Σₘ₌₁^{m}^{₁}M−m pairwise GMs).

At 525, AP 105 may determine (select) a best pairwise GM (i.e., a GM₂ for a user pair (i₁, j₁), where the user pair (iᵢ, jᵢ) is the user pair that gives the largest pairwise GM) from the first and second sets of pairwise GMs calculated at 510 and 520. The best pairwise GM may indicate a lowest correlation between transmissions of its respective users. At 530, AP 105 may calculate higher order grouping metrics based on GM₂. In some examples, AP 105 may calculate the higher order grouping metrics using the tree-based selection techniques described with reference to FIGS. 4A-4C. At 535, AP 105 may determine (select) a best GM for each higher order set of GMs (e.g., a GM₃, GM₄, . . . GM_{M-1}). The operations at 525, 530, and 535 may be performed such that AP 105 iteratively, based on the first portion of beamforming information and the second portion of beamforming information, selects a lower order GM and determines a higher order set of GMs for each selected lower order GM.

At 540, AP 105 may select a GM from the set of GM₂, GM₃, . . . GM_{M-1}, and at 545, AP 105 may transmit, over the channel, a MU transmission associated with the selected GM.

The operations at 510 may define a first phase of operation, and the operations at 520, 525, 530, 535, and 540 may define a second phase of operation. Performing the operations of the first phase prior to receiving all of the second portion of beamforming information may decrease the time needed to perform all of the operations of the first phase and the second phase, and in some examples may enable a GM to be selected, at 535, prior to transmitting a first PPDU following receipt of all of the beamforming information for the M STAs.

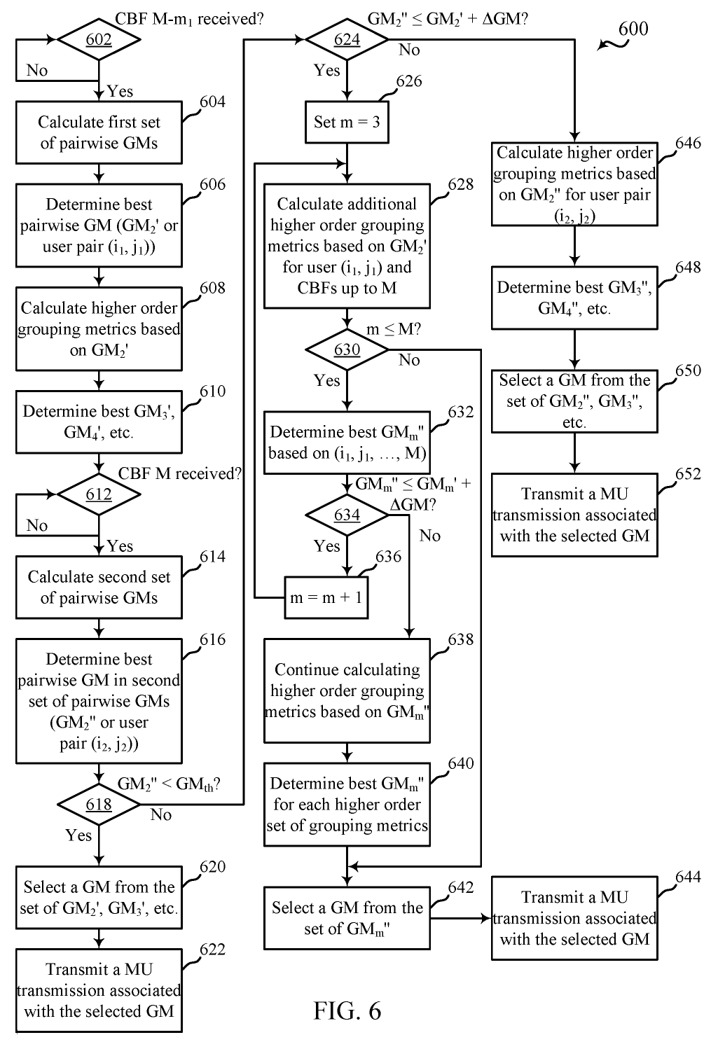

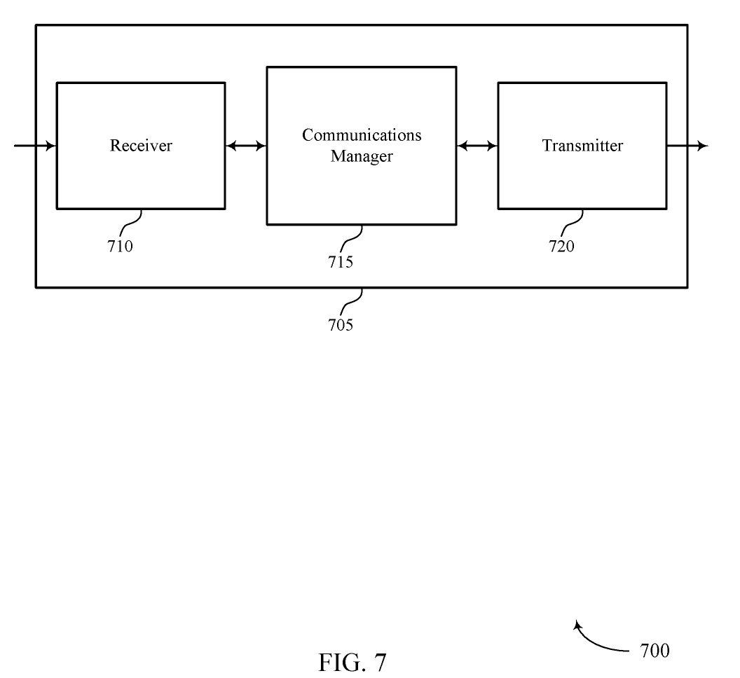

FIG. 6 shows a flow chart that illustrates an example of a method 600 for phased determination of channel-correlation based grouping metrics for MU transmissions, in accordance with various aspects of the present disclosure. Method 600 may be performed by any of the APs 105 or STAs 110 discussed in the present disclosure, but for clarity, method 600 will be described from the perspective of an AP 105 of FIG. 1 that sequentially receives beamforming information from a plurality of STAs 110 of FIG. 1. In some examples, AP 105 may sequentially receive beamforming information from a plurality of STAs 110, as described with reference to FIG. 2. It is to be understood that method 600 is just one example of techniques for determining channel-correlation based grouping metrics for MU transmission in a phased manner (e.g., in multiple phases), and the operations of method 600 may be rearranged, performed by other devices and component thereof, and/or otherwise modified such that other implementations are possible.

Prior to 602, AP 105 may begin sequentially receiving beamforming information (e.g., CBFs) for a channel from a plurality of STAs 110. In some examples, the beamforming information may be sequentially received as described with reference to FIG. 2. At 602, AP 105 may determine whether all of a first portion of beamforming information has been received. For example, AP 105 may determine whether beamforming information has been received from M−m₁ of the STAs. M may be a total number of STAs from which beamforming information will be received, and m₁ may have a value of 1 to M−2. If AP 105 has not received beamforming information from the M−m₁ STAs, AP 105 may make the determination at 602 again; otherwise, the method 600 may continue at 604.

At 604, AP 105 may calculate (determine) a first set of pairwise GMs (e.g., C₂^{M-m}^{₁} pairwise GMs). For example, if m₁=1 and M=8, AP 105 may calculate C₂⁷=21 pairwise GMs after receiving beamforming information from a set of 7 STAs. In some examples, m₁ may be determined based on the time needed to calculate the first set of pairwise GMs before receiving all of a second portion of beamforming information (or all of the beamforming information).

At 606, AP 105 may determine (select) a best pairwise GM (i.e., a GM₂′ or user pair (i₁, j₁)) from the first set of pairwise GMs calculated at 604. The best pairwise GM may indicate a lowest correlation between transmissions of its respective users. At 608, AP 105 may calculate higher order grouping metrics based on GM₂′. In some examples, AP 105 may calculate the higher order grouping metrics using the tree-based selection techniques described with reference to FIGS. 4A-4C. At 610, AP 105 may determine (select) a best GM for each higher order set of GMs (e.g., a GM₃′, GM₄′, GM_{M-m1-i}′). The operations at 606, 608, and 610 may be performed such that AP 105 iteratively, based on the first portion of beamforming information, selects a lower order GM and determines a higher order set of GMs for each selected lower order GM.

At 612, AP 105 may determine whether all of a second portion of beamforming information has been received, in addition to all of the first portion of beamforming information. For example, AP 105 may determine whether beamforming information has been received from all M STAs. If AP 105 has not received beamforming information from all M STAs, AP 105 may make the determination at 612 again; otherwise, the method 600 may continue at 614.

At 614, AP 105 may calculate a second set of pairwise GMs (e.g., Σₘ₌₁^{m}^{₁}M−m pairwise GMs). At 616, AP 105 may determine (select) a best pairwise GM (i.e., GM₂″ or user pair (i₂j₂)) from the second set of pairwise GMs calculated at 614. The best pairwise GM may indicate a lowest correlation between transmissions of its respective users.

At 618, AP 105 may determine whether GM₂″ is less than a predetermined threshold correlation value GMₜₕ (i.e., whether GM₂″<GMₜₕ). If GM₂″ is less than the predetermined threshold correlation value, AP 105 may determine that no other GMs need to be determined, and at 620, AP 105 may select a GM from the set of GM₂′, GM₃′, . . . GM_{M-1}′. At 622, AP 105 may transmit, over the channel, a MU transmission associated with the selected GM. If GM₂″ is greater than the predetermined threshold correlation value, the method 600 may continue at 624.

At 624, AP 105 may determine whether GM₂″≤GM₂′+ΔGM, where ΔGM is an optional small positive value that may reduce GM calculations when GM₂″ is comparable to GM₂′. If GM₂″≤GM₂′+ΔGM, AP 105 may set m=3 at 626. At 628, AP 105 may calculate additional higher order GMs based on the GM₂′ for user pair (i₁, j₁) and CBFs up to M (e.g., a set of GMₘ″). In some examples, intermediate GMs calculated at 608 may be leveraged for these calculations. At 630, AP 105 may determine whether m≤M. If m≤M, the method 600 may continue at 632; otherwise, the method 600 may continue at 642. At 632, AP 105 may determine a best GMₘ″ based on STAs i₁, j₁, . . . M). At 634, AP 105 may determine whether GMₘ″≤GMₘ′+ΔGM. If GMₘ″≤GMₘ′+ΔGM, m may be incremented at 636 (e.g., m=m+1), and the method 600 may return to 628 for another iteration through 628, 630, 632, 634, and/or 636.

If AP 105 determines at 634 that GGMₘ″>GMₘ′+ΔGM, the method may continue at 638. At 638, AP 105 may continue calculating higher order GMs based on GMₘ″. In some examples, intermediate GMs calculated at 608 may be leveraged for these calculations. At 640, AP 105 may determine a best GMₘ″ for each higher order set of GMs. In some examples, AP 105 may calculate the additional higher order grouping metrics, at 628 and 638, using the tree-based selection techniques described with reference to FIGS. 4A-4C. The operations at 628, 630, 632, 634, 636, 638, and 640 may be performed such that AP 105 iteratively, based on the first portion of beamforming information and second portion of beamforming information, selects a lower order GM and determines a higher order set of GMs for each selected lower order GM. Because all possible GMₘ″s may or may not be calculated at 628 or 638, the operations at 628, 630, 632, 634, 636, 638, and 640 may be considered a partial tree expansion of GMs.

At 642, AP 105 may select a GM from the set of GMₘ″, and at 644, AP 105 may transmit, over the channel, a MU transmission associated with the selected GM.

If GM₂″>GM₂′+ΔGM, the method 600 may continue at 646. At 646, AP 105 may calculate higher order grouping metrics based on the GM₂″ for user pair (i₂j₂). In some examples, intermediate GMs calculated at 608 may be leveraged for these calculations. In some examples, AP 105 may calculate the higher order grouping metrics using the tree-based selection techniques described with reference to FIGS. 4A-4C. At 648, AP 105 may determine (select) a best GM for each higher order set of GMs (e.g., a GM₃″, GM₄″, . . . GM_{M-1}″). The operations at 646 and 648 may be performed such that AP 105 iteratively, based on the first portion of beamforming information and second portion of beamforming information, selects a lower order GM and determines a higher order set of GMs for each selected lower order GM.

At 650, AP 105 may select a GM from the set of GM₂″, GM₃″, GM_{M-1}″, and at 652, AP 105 may transmit, over the channel, a MU transmission associated with the selected GM.

The operations at 604, 606, 608, and 610 may define a first phase of operation, and the operations at 614-652 may define a second phase of operation. Performing the operations of the first phase prior to receiving all of the second portion of beamforming information may decrease the time needed to perform all of the operations of the first phase and the second phase, and in some examples may enable a GM to be selected, at 620, 642, or 650, prior to transmitting a first PPDU following receipt of all of the beamforming information for the M STAs. In contrast to method 500, the time saving of method 600 is probabilistic, as the GM calculations performed after receiving the second portion of beamforming information may range from all GM calculations except C₂^{M-m}^{₁} pairwise GM calculations to only Σₘ₌₁^{m}^{₁}M−m₁ pairwise GM calculations.

In some examples of method 600, a check may be made after 610 to determine whether one or more of the GMs calculated during the first phase of operation (e.g., GM₃′, GM₄′, . . . or GM_{M-m1-1}′) is satisfactory for transmitting a MU transmission over the channel. In some examples, a GM may be determined satisfactory if it satisfies one or more parameters, such as a predetermined threshold correlation value (e.g., a predetermined MU-SINR), an association with a threshold number of STAs or channels, or a combination thereof. In some examples, the threshold number of STAs or channels may be a number of STAs or channels close to a historic average number of STAs or channels in a MU group associated with a MU transmission.

In some examples of method 500 (described with reference to FIG. 5) or 600 (described with reference to FIG. 6), the calculations of GMs may be partitioned into more than two phases. For example the calculations performed in the first phase of operation may instead be performed over multiple phases of operations, with each of the phases being performed after receipt of an additional sub-portion of beamforming information. Additionally or alternatively, each phase of operation may be performed in a separate one or more threads, partly or wholly in parallel. Performing the phases of operations in parallel threads may increase the time saving of calculating/selecting GMs in different phases of operations.

FIG. 7 shows a block diagram 700 of a wireless device 705 that supports phased determination of channel-correlation-based grouping metrics for multiple user transmissions in accordance with various aspects of the present disclosure. Wireless device 705 may be an example of aspects of an access point (AP) 105 as described with reference to FIG. 1. Wireless device 705 may include receiver 710, communications manager 715, and transmitter 720. Wireless device 705 may also include a processor. Each of these components may be in communication with one another (e.g., via one or more buses).

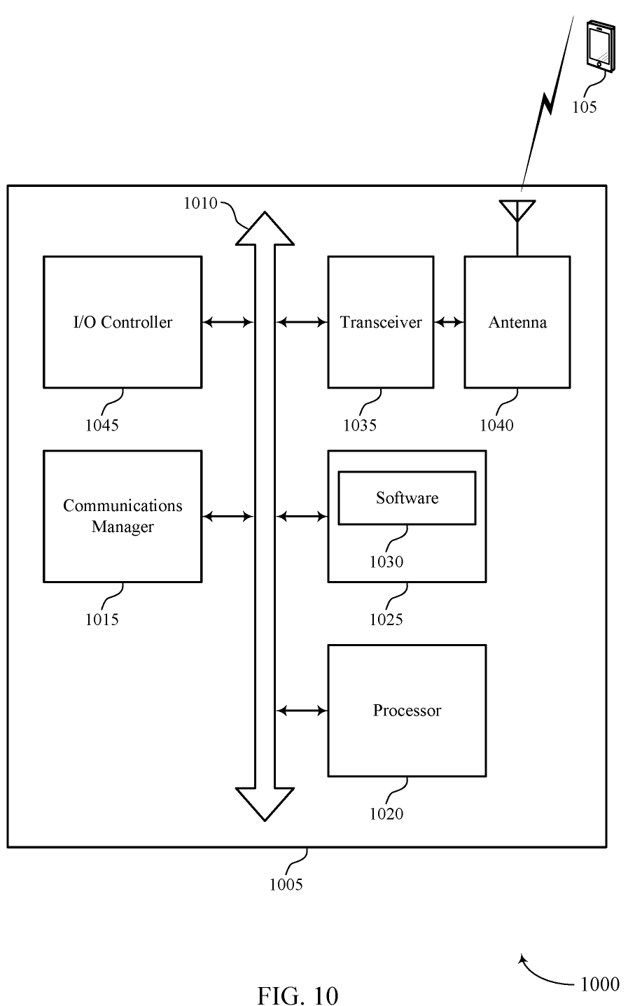

Receiver 710 may receive information such as packets, user data, or control information associated with various information channels (e.g., control channels, data channels, and information related to phased determination of channel-correlation-based grouping metrics for multiple user transmissions, etc.). Information may be passed on to other components of the device. The receiver 710 may be an example of aspects of the transceiver 1035 described with reference to FIG. 10.

Communications manager 715 may be an example of aspects of the communications manager 1015 described with reference to FIG. 10.

Communications manager 715 may sequentially receive beamforming information for a channel from a set of wireless stations, the beamforming information including a first portion of beamforming information and a second portion of beamforming information, determine, based on the first portion of beamforming information, and before receiving all of the second portion of beamforming information, a first set of grouping metrics of a set of grouping metrics for the set of wireless stations, the set of grouping metrics indicating correlations between transmissions made by the set of wireless stations over the channel, determine, based on the second portion of beamforming information, a second set of grouping metrics of the set of grouping metrics for the set of wireless stations, select a grouping metric from the first set of grouping metrics or the second set of grouping metrics, and transmit, over the channel, a multiple user transmission associated with the selected grouping metric.

Transmitter 720 may transmit signals generated by other components of the device. In some examples, the transmitter 720 may be collocated with a receiver 710 in a transceiver module. For example, the transmitter 720 may be an example of aspects of the transceiver 1035 described with reference to FIG. 10. The transmitter 720 may include a single antenna, or it may include a set of antennas.

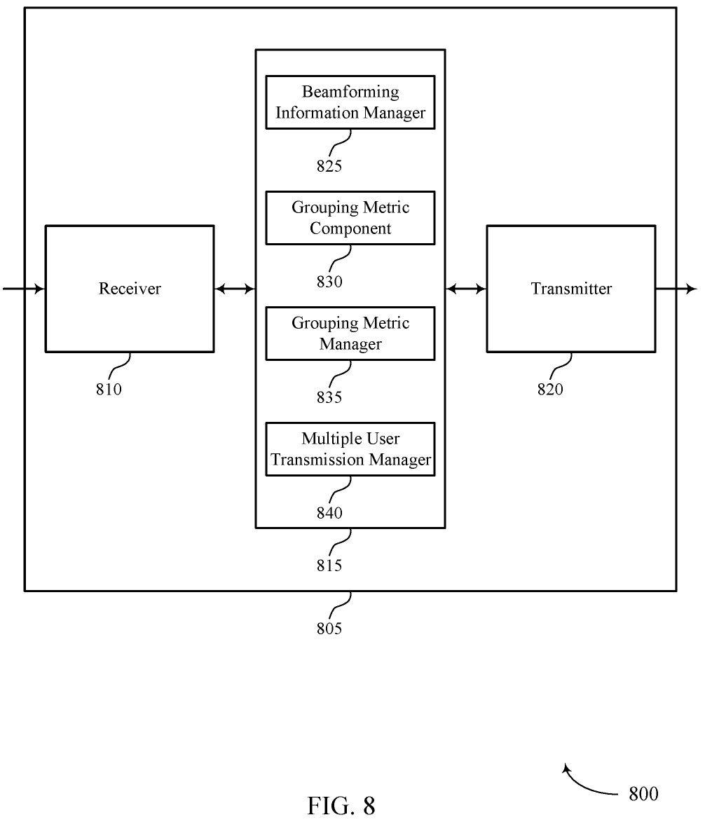

FIG. 8 shows a block diagram 800 of a wireless device 805 that supports phased determination of channel-correlation-based grouping metrics for multiple user transmissions in accordance with various aspects of the present disclosure. Wireless device 805 may be an example of aspects of a wireless device 705 or an AP 105 as described with reference to FIGS. 1 and 7. Wireless device 805 may include receiver 810, communications manager 815, and transmitter 820. Wireless device 805 may also include a processor. Each of these components may be in communication with one another (e.g., via one or more buses).

Receiver 810 may receive information such as packets, user data, or control information associated with various information channels (e.g., control channels, data channels, and information related to phased determination of channel-correlation-based grouping metrics for multiple user transmissions, etc.). Information may be passed on to other components of the device. The receiver 810 may be an example of aspects of the transceiver 1035 described with reference to FIG. 10.

Communications manager 815 may be an example of aspects of the communications manager 1015 described with reference to FIG. 10.

Communications manager 815 may also include beamforming information manager 825, grouping metric component 830, grouping metric manager 835, and multiple user transmission manager 840.

Beamforming information manager 825 may sequentially receive beamforming information for a channel from a set of wireless stations, the beamforming information including a first portion of beamforming information and a second portion of beamforming information. In some cases, the beamforming information includes feedback signal-to-noise ratio (SNR) values and beamforming feedback matrices.

Grouping metric component 830 may determine, based on the first portion of beamforming information, and before receiving all of the second portion of beamforming information, a first set of grouping metrics of a set of grouping metrics for the set of wireless stations, the set of grouping metrics indicating correlations between transmissions made by the set of wireless stations over the channel, determine, based on the second portion of beamforming information, a second set of grouping metrics of the set of grouping metrics for the set of wireless stations, determine no other grouping metrics within the second set of grouping metrics when the comparing indicates that the selected pairwise grouping metric indicates more correlation between transmissions than the predetermined threshold correlation value, iteratively select a lower order grouping metric and determining a higher order set of grouping metrics, for each of a set of lower order sets of grouping metrics, based on the comparison and based on the first portion of beamforming information and the second portion of beamforming information, and determine the second set of grouping metrics of the set of grouping metrics when the comparing indicates that the pairwise grouping metric indicates more correlation between transmissions than the predetermined threshold correlation value. In some cases, determining the first set of grouping metrics includes: determining a first set of pairwise grouping metrics based on beamforming information received for a first set of the set of wireless stations. In some cases, determining the first set of grouping metrics further includes: iteratively selecting a lower order grouping metric and determining a higher order set of grouping metrics for each of a set of lower order sets of grouping metrics based on the first portion of beamforming information. In some cases, the first set of grouping metrics of the set of grouping metrics is determined in at least two phases, after receiving beamforming information from different subsets of the set of wireless stations.

Grouping metric manager 835 may select a grouping metric from the first set of grouping metrics or the second set of grouping metrics.

Multiple user transmission manager 840 may transmit, over the channel, a multiple user transmission associated with the selected grouping metric.

Transmitter 820 may transmit signals generated by other components of the device. In some examples, the transmitter 820 may be collocated with a receiver 810 in a transceiver module. For example, the transmitter 820 may be an example of aspects of the transceiver 1035 described with reference to FIG. 10. The transmitter 820 may include a single antenna, or it may include a set of antennas.

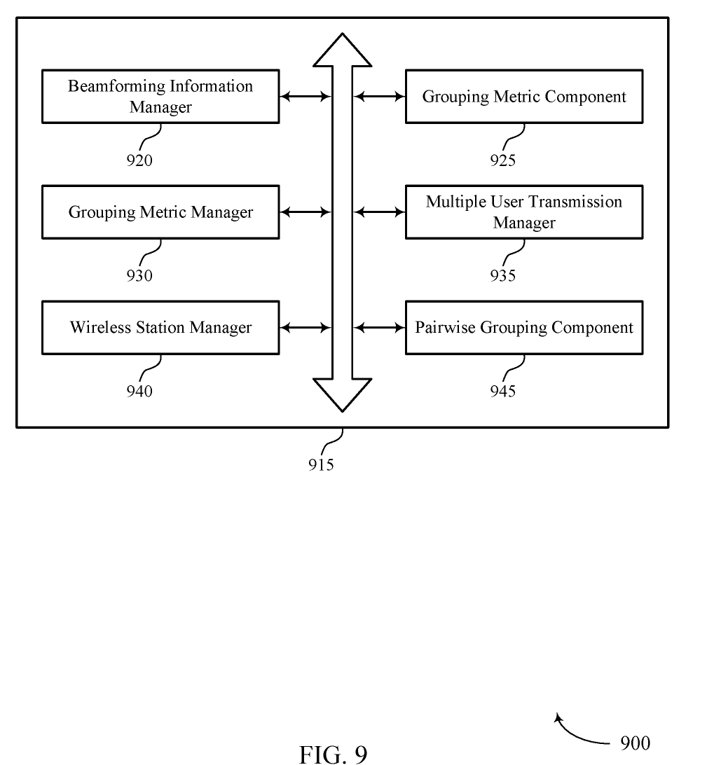

FIG. 9 shows a block diagram 900 of a communications manager 915 that supports phased determination of channel-correlation-based grouping metrics for multiple user transmissions in accordance with various aspects of the present disclosure. The communications manager 915 may be an example of aspects of a communications manager 715, a communications manager 815, or a communications manager 1015 described with reference to FIGS. 7, 8, and 10. The communications manager 915 may include beamforming information manager 920, grouping metric component 925, grouping metric manager 930, multiple user transmission manager 935, wireless station manager 940, and pairwise grouping component 945. Each of these modules may communicate, directly or indirectly, with one another (e.g., via one or more buses).

Beamforming information manager 920 may sequentially receive beamforming information for a channel from a set of wireless stations, the beamforming information including a first portion of beamforming information and a second portion of beamforming information. In some cases, the beamforming information includes feedback SNR values and beamforming feedback matrices.

Grouping metric component 925 may determine, based on the first portion of beamforming information, and before receiving all of the second portion of beamforming information, a first set of grouping metrics of a set of grouping metrics for the set of wireless stations, the set of grouping metrics indicating correlations between transmissions made by the set of wireless stations over the channel, determine, based on the second portion of beamforming information, a second set of grouping metrics of the set of grouping metrics for the set of wireless stations, determine no other grouping metrics within the second set of grouping metrics when the comparing indicates that the selected pairwise grouping metric indicates more correlation between transmissions than the predetermined threshold correlation value, iteratively select a lower order grouping metric and determining a higher order set of grouping metrics, for each of a set of lower order sets of grouping metrics, based on the comparison and based on the first portion of beamforming information and the second portion of beamforming information, and determine the second set of grouping metrics of the set of grouping metrics when the comparing indicates that the pairwise grouping metric indicates more correlation between transmissions than the predetermined threshold correlation value. In some cases, determining the first set of grouping metrics includes: determining a first set of pairwise grouping metrics based on beamforming information received for a first set of the set of wireless stations. In some cases, determining the first set of grouping metrics further includes: iteratively selecting a lower order grouping metric and determining a higher order set of grouping metrics for each of a set of lower order sets of grouping metrics based on the first portion of beamforming information. In some cases, the first set of grouping metrics of the set of grouping metrics is determined in at least two phases, after receiving beamforming information from different subsets of the set of wireless stations.

Grouping metric manager 930 may select a grouping metric from the first set of grouping metrics or the second set of grouping metrics.

Multiple user transmission manager 935 may transmit, over the channel, a multiple user transmission associated with the selected grouping metric.

Wireless station manager 940 may determine a number of wireless stations in the first set of the set of wireless stations based on a time to determine the first set of grouping metrics before receiving the second portion of the beamforming information.

Pairwise grouping component 945 may select a pairwise grouping metric from the second set of pairwise grouping metrics, the pairwise grouping metric indicating a lowest correlation between transmissions within the second set of pairwise grouping metrics, compare the selected pairwise grouping metric to a predetermined threshold correlation value, select a first pairwise grouping metric from the first set of pairwise grouping metrics, the first pairwise grouping metric indicating a lowest correlation between transmissions within the first set of pairwise grouping metrics, select a second pairwise grouping metric from the second set of pairwise grouping metrics, the second pairwise grouping metric indicating a lowest correlation between transmissions within the second set of pairwise grouping metrics, compare the second pairwise grouping metric to the first pairwise grouping metric, and select a pairwise grouping metric from the first set of pairwise grouping metrics, the pairwise grouping metric indicating a lowest correlation between transmissions within the first set of pairwise grouping metrics. In some cases, determining the second set of grouping metrics includes: determining a second set of pairwise grouping metrics based on the second portion of beamforming information. In some cases, determining the first set of grouping metrics includes: determining a first set of pairwise grouping metrics based on beamforming information received for a first set of the set of wireless stations.

FIG. 10 shows a diagram of a system 1000 including a device 1005 that supports phased determination of channel-correlation-based grouping metrics for multiple user transmissions in accordance with various aspects of the present disclosure. Device 1005 may be an example of or include the components of wireless device 705, wireless device 805, or an AP 105 as described above, e.g., with reference to FIGS. 1, 7 and 8. Device 1005 may include components for bi-directional voice and data communications including components for transmitting and receiving communications, including communications manager 1015, processor 1020, memory 1025, software 1030, transceiver 1035, antenna 1040, and I/O controller 1045. These components may be in electronic communication via one or more busses (e.g., bus 1010).

Processor 1020 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1020 may be configured to operate a memory array using a memory controller. In other cases, a memory controller may be integrated into processor 1020. Processor 1020 may be configured to execute computer-readable instructions stored in a memory to perform various functions (e.g., functions or tasks supporting phased determination of channel-correlation-based grouping metrics for multiple user transmissions).

Memory 1025 may include random access memory (RAM) and read only memory (ROM). The memory 1025 may store computer-readable, computer-executable software 1030 including instructions that, when executed, cause the processor to perform various functions described herein. In some cases, the memory 1025 may contain, among other things, a basic input/output system (BIOS) which may control basic hardware and/or software operation such as the interaction with peripheral components or devices.

Software 1030 may include code to implement aspects of the present disclosure, including code to support phased determination of channel-correlation-based grouping metrics for multiple user transmissions. Software 1030 may be stored in a non-transitory computer-readable medium such as system memory or other memory. In some cases, the software 1030 may not be directly executable by the processor but may cause a computer (e.g., when compiled and executed) to perform functions described herein.

Transceiver 1035 may communicate bi-directionally, via one or more antennas, wired, or wireless links as described above. For example, the transceiver 1035 may represent a wireless transceiver and may communicate bi-directionally with another wireless transceiver. The transceiver 1035 may also include a modem to modulate the packets and provide the modulated packets to the antennas for transmission, and to demodulate packets received from the antennas.

In some cases, the wireless device may include a single antenna 1040. However, in some cases the device may have more than one antenna 1040, which may be capable of concurrently transmitting or receiving multiple wireless transmissions.

I/O controller 1045 may manage input and output signals for device 1005. I/O controller 1045 may also manage peripherals not integrated into device 1005. In some cases, I/O controller 1045 may represent a physical connection or port to an external peripheral. In some cases, I/O controller 1045 may utilize an operating system such as iOS®, ANDROID®, MS-DOS®, MS-WINDOWS®, OS/2®, UNIX®, LINUX®, or another known operating system.

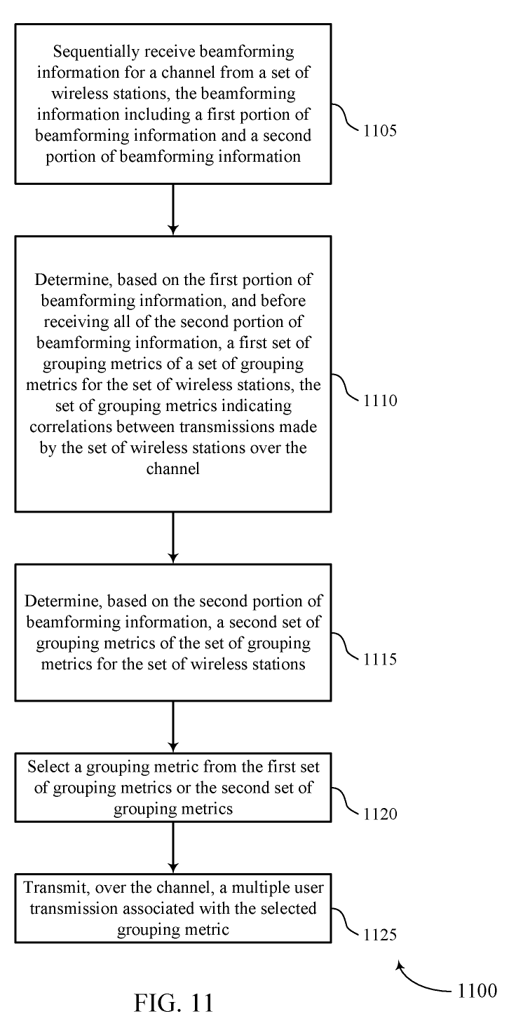

FIG. 11 shows a flowchart illustrating a method 1100 for phased determination of channel-correlation-based grouping metrics for multiple user transmissions in accordance with various aspects of the present disclosure. The operations of method 1100 may be implemented by an AP 105 or its components as described herein. For example, the operations of method 1100 may be performed by a communications manager as described with reference to FIGS. 7 through 10. In some examples, an AP 105 may execute a set of codes to control the functional elements of the device to perform the functions described below. Additionally or alternatively, the AP 105 may perform aspects the functions described below using special-purpose hardware.

At block 1105 the AP 105 may sequentially receive beamforming information for a channel from a plurality of wireless stations, the beamforming information comprising a first portion of beamforming information and a second portion of beamforming information. The operations of block 1105 may be performed according to the methods described with reference to FIGS. 1 through 6. In certain examples, aspects of the operations of block 1105 may be performed by a beamforming information manager as described with reference to FIGS. 7 through 10.

At block 1110 the AP 105 may determine, based at least in part on the first portion of beamforming information, and before receiving all of the second portion of beamforming information, a first set of grouping metrics of a plurality of grouping metrics for the plurality of wireless stations, the plurality of grouping metrics indicating correlations between transmissions made by the plurality of wireless stations over the channel. The operations of block 1110 may be performed according to the methods described with reference to FIGS. 1 through 6. In certain examples, aspects of the operations of block 1110 may be performed by a grouping metric component as described with reference to FIGS. 7 through 10.

At block 1115 the AP 105 may determine, based at least in part on the second portion of beamforming information, a second set of grouping metrics of the plurality of grouping metrics for the plurality of wireless stations. The operations of block 1115 may be performed according to the methods described with reference to FIGS. 1 through 6. In certain examples, aspects of the operations of block 1115 may be performed by a grouping metric component as described with reference to FIGS. 7 through 10.

At block 1120 the AP 105 may select a grouping metric from the first set of grouping metrics or the second set of grouping metrics. The operations of block 1120 may be performed according to the methods described with reference to FIGS. 1 through 6. In certain examples, aspects of the operations of block 1120 may be performed by a grouping metric manager as described with reference to FIGS. 7 through 10.

At block 1125 the AP 105 may transmit, over the channel, a multiple user transmission associated with the selected grouping metric. The operations of block 1125 may be performed according to the methods described with reference to FIGS. 1 through 6. In certain examples, aspects of the operations of block 1125 may be performed by a multiple user transmission manager as described with reference to FIGS. 7 through 10.

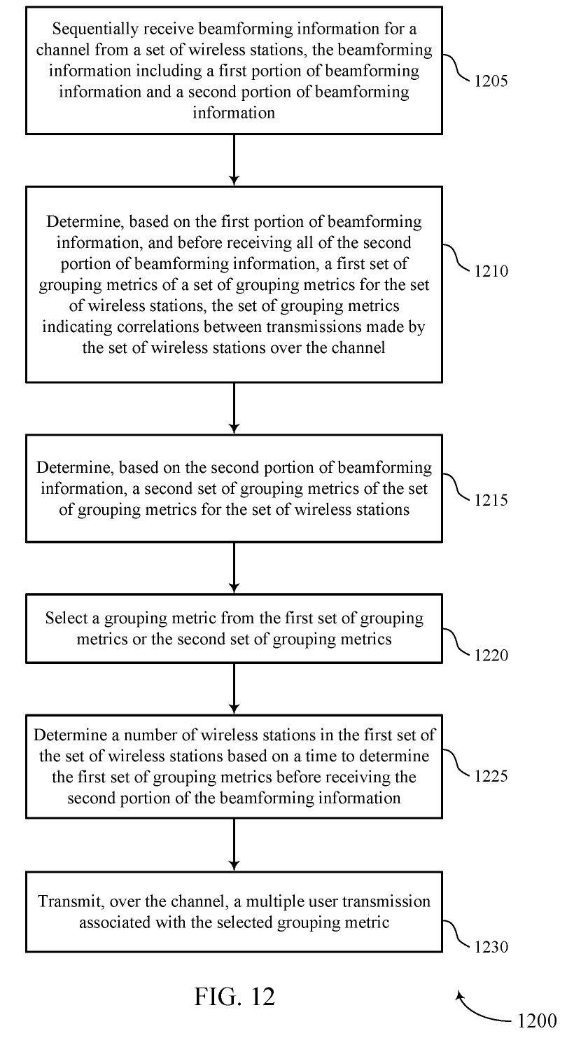

FIG. 12 shows a flowchart illustrating a method 1200 for phased determination of channel-correlation-based grouping metrics for multiple user transmissions in accordance with various aspects of the present disclosure. The operations of method 1200 may be implemented by an AP 105 or its components as described herein. For example, the operations of method 1200 may be performed by a communications manager as described with reference to FIGS. 7 through 10. In some examples, an AP 105 may execute a set of codes to control the functional elements of the device to perform the functions described below. Additionally or alternatively, the AP 105 may perform aspects the functions described below using special-purpose hardware.

At block 1205 the AP 105 may sequentially receive beamforming information for a channel from a plurality of wireless stations, the beamforming information comprising a first portion of beamforming information and a second portion of beamforming information. The operations of block 1205 may be performed according to the methods described with reference to FIGS. 1 through 6. In certain examples, aspects of the operations of block 1205 may be performed by a beamforming information manager as described with reference to FIGS. 7 through 10.

At block 1210 the AP 105 may determine, based at least in part on the first portion of beamforming information, and before receiving all of the second portion of beamforming information, a first set of grouping metrics of a plurality of grouping metrics for the plurality of wireless stations, the plurality of grouping metrics indicating correlations between transmissions made by the plurality of wireless stations over the channel. The operations of block 1210 may be performed according to the methods described with reference to FIGS. 1 through 6. In certain examples, aspects of the operations of block 1210 may be performed by a grouping metric component as described with reference to FIGS. 7 through 10.

At block 1215 the AP 105 may determine, based at least in part on the second portion of beamforming information, a second set of grouping metrics of the plurality of grouping metrics for the plurality of wireless stations. The operations of block 1215 may be performed according to the methods described with reference to FIGS. 1 through 6. In certain examples, aspects of the operations of block 1215 may be performed by a grouping metric component as described with reference to FIGS. 7 through 10.

At block 1220 the AP 105 may select a grouping metric from the first set of grouping metrics or the second set of grouping metrics. The operations of block 1220 may be performed according to the methods described with reference to FIGS. 1 through 6. In certain examples, aspects of the operations of block 1220 may be performed by a grouping metric manager as described with reference to FIGS. 7 through 10.

At block 1225 the AP 105 may determine a number of wireless stations in the first set of the plurality of wireless stations based at least in part on a time to determine the first set of grouping metrics before receiving the second portion of the beamforming information. The operations of block 1225 may be performed according to the methods described with reference to FIGS. 1 through 6. In certain examples, aspects of the operations of block 1225 may be performed by a wireless station manager as described with reference to FIGS. 7 through 10.

At block 1230 the AP 105 may transmit, over the channel, a multiple user transmission associated with the selected grouping metric. The operations of block 1230 may be performed according to the methods described with reference to FIGS. 1 through 6. In certain examples, aspects of the operations of block 1230 may be performed by a multiple user transmission manager as described with reference to FIGS. 7 through 10.

In some cases, determining the first set of grouping metrics comprises: determining a first set of pairwise grouping metrics based at least in part on beamforming information received for a first set of the plurality of wireless stations.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, comprising:
a memory that stores instructions; and
a processor coupled with the memory, wherein the processor and the memory are configured to:
sequentially receive beamforming information for a channel from a plurality of wireless stations, the beamforming information comprising a first portion of beamforming information and a second portion of beamforming information;
determine, based at least in part on the first portion of beamforming information, and before receiving all of the second portion of beamforming information, a first set of grouping metrics of a plurality of grouping metrics for the plurality of wireless stations, the plurality of grouping metrics indicating correlations between transmissions made by the plurality of wireless stations over the channel;
determine, based at least in part on the second portion of beamforming information, a second set of grouping metrics of the plurality of grouping metrics for the plurality of wireless stations;
select a grouping metric from the first set of grouping metrics or the second set of grouping metrics; and
transmit, over the channel, a multiple user transmission associated with the selected grouping metric.

2. The apparatus of claim 1, wherein the processor and the memory are configured to determine the first set of grouping metrics by being configured to determine a first set of pairwise grouping metrics based at least in part on beamforming information received for a first set of the plurality of wireless stations.

3. The apparatus of claim 2, wherein the processor and the memory are further configured to:
determine a number of wireless stations in the first set of the plurality of wireless stations based at least in part on a time to determine the first set of grouping metrics before receiving the second portion of the beamforming information.

4. The apparatus of claim 2, wherein the processor and the memory are configured to determine the first set of grouping metrics by being configured to iteratively select a lower order grouping metric and determine a higher order set of grouping metrics for each of a plurality of lower order sets of grouping metrics based at least in part on the first portion of beamforming information.

5. The apparatus of claim 4, wherein the processor and the memory are configured to determine the second set of grouping metrics by being configured to determine a second set of pairwise grouping metrics based at least in part on the second portion of beamforming information.

6. The apparatus of claim 5, wherein the processor and the memory are further configured to:
select a pairwise grouping metric from the second set of pairwise grouping metrics, the pairwise grouping metric indicating a lowest correlation between transmissions within the second set of pairwise grouping metrics;
compare the selected pairwise grouping metric to a predetermined threshold correlation value; and
determine no other grouping metrics within the second set of grouping metrics when the comparing indicates that the selected pairwise grouping metric indicates more correlation between transmissions than the predetermined threshold correlation value.

7. The apparatus of claim 5, wherein the processor and the memory are further configured to:
select a first pairwise grouping metric from the first set of pairwise grouping metrics, the first pairwise grouping metric indicating a lowest correlation between transmissions within the first set of pairwise grouping metrics;
select a second pairwise grouping metric from the second set of pairwise grouping metrics, the second pairwise grouping metric indicating a lowest correlation between transmissions within the second set of pairwise grouping metrics;
compare the second pairwise grouping metric to the first pairwise grouping metric; and
iteratively select a lower order grouping metric and determining a higher order set of grouping metrics, for each of a plurality of lower order sets of grouping metrics, based at least in part on the comparison and based at least in part on the first portion of beamforming information and the second portion of beamforming information.

8. The apparatus of claim 2, wherein the processor and the memory are further configured to:
select a pairwise grouping metric from the first set of pairwise grouping metrics, the pairwise grouping metric indicating a lowest correlation between transmissions within the first set of pairwise grouping metrics;
compare the selected pairwise grouping metric to a predetermined threshold correlation value; and
determine the second set of grouping metrics of the plurality of grouping metrics when the comparing indicates that the pairwise grouping metric indicates more correlation between transmissions than the predetermined threshold correlation value.

9. The apparatus of claim 1, wherein the first set of grouping metrics of the plurality of grouping metrics is determined in at least two phases, after receiving beamforming information from different subsets of the plurality of wireless stations.

10. The apparatus of claim 1, wherein the beamforming information comprises feedback signal-to-noise ratio (SNR) values and beamforming feedback matrices.

11. The apparatus of claim 1, wherein the apparatus is a wireless communication terminal and further comprises an antenna and a transceiver.

12. A method for wireless communication, comprising:
sequentially receiving beamforming information from a plurality of wireless stations, the beamforming information comprising a first portion of beamforming information and a second portion of beamforming information;
determining, based at least in part on the first portion of beamforming information, and before receiving all of the second portion of beamforming information, a first set of grouping metrics of a plurality of grouping metrics for the plurality of wireless stations, the plurality of grouping metrics indicating correlations between transmissions made by the plurality of wireless stations;
determining, based at least in part on the second portion of beamforming information, a second set of grouping metrics of the plurality of grouping metrics for the plurality of wireless stations;
selecting a grouping metric from the first set of grouping metrics or the second set of grouping metrics; and
transmitting a multi-user transmission associated with the selected grouping metric.

13. The method of claim 12, wherein determining the first set of grouping metrics comprises:
determining a first set of pairwise grouping metrics based at least in part on beamforming information received for a first set of the plurality of wireless stations.

14. The method of claim 13, further comprising:
determining a number of wireless stations in the first set of the plurality of wireless stations based at least in part on a time to determine the first set of grouping metrics before receiving all of the second portion of the beamforming information.

15. The method of claim 13, wherein determining the first set of grouping metrics further comprises:
iteratively, based at least in part on the first portion of beamforming information, selecting a lower order grouping metric and determining a higher order set of grouping metrics for each selected lower order grouping metric.

16. The method of claim 15, wherein determining the second set of grouping metrics comprises:
determining a second set of pairwise grouping metrics based at least in part on the second portion of beamforming information.

17. The method of claim 16, further comprising:
selecting a pairwise grouping metric from the second set of pairwise grouping metrics, the pairwise grouping metric indicating a lowest correlation between transmissions within the second set of pairwise grouping metrics;
comparing the selected pairwise grouping metric to a predetermined threshold correlation value; and
determining no other grouping metrics within the second set of grouping metrics when the comparing indicates that the selected pairwise grouping metric indicates more correlation between transmissions than the predetermined threshold correlation value.

18. The method of claim 16, further comprising:
selecting a first pairwise grouping metric from the first set of pairwise grouping metrics, the first pairwise grouping metric indicating a lowest correlation between transmissions within the first set of pairwise grouping metrics;
selecting a second pairwise grouping metric from the second set of pairwise grouping metrics, the second pairwise grouping metric indicating a lowest correlation between transmissions within the second set of pairwise grouping metrics;
comparing the second pairwise grouping metric to the first pairwise grouping metric; and
iteratively, based at least in part on the first portion of beamforming information and the second portion of beamforming information, selecting a lower order grouping metric and determining a higher order set of grouping metrics, for each selected lower order grouping metric.

19. The method of claim 13, further comprising:
selecting a pairwise grouping metric from the first set of pairwise grouping metrics, the pairwise grouping metric indicating a lowest correlation between transmissions within the first set of pairwise grouping metrics;
comparing the selected pairwise grouping metric to a predetermined threshold correlation value; and
determining the second set of grouping metrics of the plurality of grouping metrics when the comparing indicates that the pairwise grouping metric indicates more correlation between transmissions than the predetermined threshold correlation value.

20. A non-transitory computer readable medium storing code for wireless communication, the code comprising instructions executable by a processor to:
sequentially receive beamforming information for a channel from a plurality of wireless stations, the beamforming information comprising a first portion of beamforming information and a second portion of beamforming information;
determine, based at least in part on the first portion of beamforming information, and before receiving all of the second portion of beamforming information, a first set of grouping metrics of a plurality of grouping metrics for the plurality of wireless stations, the plurality of grouping metrics indicating correlations between transmissions made by the plurality of wireless stations over the channel;
determine, based at least in part on the second portion of beamforming information, a second set of grouping metrics of the plurality of grouping metrics for the plurality of wireless stations;
select a grouping metric from the first set of grouping metrics or the second set of grouping metrics; and
transmit, over the channel, a multiple user transmission associated with the selected grouping metric.
